(19) United States
(12) Patent Application Publication
(10) Pub. No.: US 2026/0371266 A1
(43) Pub. Date: Nov. 19, 2026

(54) COMMUNICATION DEVICE OPERATION

(71) Applicant: Telefonaktiebolaget LM Ericsson (publ), Stockholm (SE)

(72) Inventors: Muhammad Ali KAZMI, SUNDBYBERG (SE); Santhan THANGARASA, VÄLLINGBY (SE); Ritesh SHREEVASTAV, UPPLANDS VÄSBY (SE); Deep SHRESTHA, LINKÖPING (SE); Iana SIOMINA, TÄBY (SE)

(73) Assignee: Telefonaktiebolaget LM Ericsson (publ), Stockholm (SE)

(21) Appl. No.: 19/154,462

(22) PCT Filed: Feb. 16, 2024
(86) PCT No.: PCT/EP2024/054073

§ 371 Date: Aug. 7, 2025

Related U.S. Application Data
(60) Provisional application No. 63/446,159, filed on Feb. 16, 2023.

(51) Int. Cl. H04W 56/00

(52) U.S. Cl. CPC H04W 56/0015

(57) ABSTRACT

The present disclosure provides a method of operating a first communication device in a communications network that includes a second communication device. The method comprises receiving a first sidelink (SL) reference signal (RS) from the second communication device. The method comprises determining that a synchronization reference source has changed or is expected to change from a first synchronization reference source to a second synchronization reference source at one or both of the first communication device and the second communication device prior to completing an SL measurement procedure on the first SL RS. The method comprises controlling operation of the first communication device based on determining that the synchronization reference source has changed or is expected to change from the first synchronization reference source to the second synchronization reference source.

### TECHNICAL FIELD

The present disclosure relates to methods of operating a communication device and the communication device configured to perform those methods.

### BACKGROUND

FIG. 1 illustrates an example of a new radio (“NR”) network (e.g., a Fifth Generation (“5G”) network) including a 5G core (“5GC”) network 130, network nodes 120a-b (e.g., 5G base station (“gNB”)), multiple communication devices 110 (also referred to as user equipment (“UE”)).

FIG. 2 illustrates an example of an NR architecture. In FIG. 2, gNB and ng-eNB (or evolved eNB) denote NR base stations (“BSs”) (one NR BS may correspond to one or more transmission and/or reception points (“TRPs”)), and the lines between the nodes illustrate the corresponding interfaces.

A location management function (“LMF”) is the location node (or location server) or positioning server in NR. There are also interactions between the location node and the gNB via the NR positioning protocol annex (“NRPPa”) (not illustrated in FIG. 2) and between the UE and the location node via a long term evolution positioning protocol (“LPP”), which is also used in NR. The interactions between the gNB and the UE is supported via the radio resource control (“RRC”) protocol.

A device-to-device (“D2D”) operation is a generic term that may include transmission and/or reception of any type of D2D signals (e.g., physical signals or physical channel) by a D2D communication capable UE and/or by a D2D discovery capable UE on a sidelink (“SL”). In some examples, SL operations enable direct communication on the SL or PC5 interface between two or more UEs. In additional or alternative examples, vehicle-to-everything (“V2X”) is a special type of D2D operation. Herein, D2D operations can also be referred to as SL operations, D2D transmissions, D2D receptions, D2D communications, proximity services (“ProSe”), or V2X.

The SL operation is specified for long term evolution (“LTE”) and NR for variety of applications and use cases (e.g., ProSe communication and discovery, vehicular communications (commonly referred to as V2X or vehicle-to-vehicle (“V2V”)). In LTE V2X, only broadcast is supported over sidelink. The NR SL is capable of broadcast, groupcast, and unicast communications. In groupcast communication, the intended receivers of a message are typically a subset of the vehicles near the transmitter, whereas in unicast communication, there is a single intended receiver. Broadcast, groupcast, and unicast transmissions for V2X operation on the SL are supported for the in-coverage, out-of-coverage, and partial-coverage scenarios. For unicast and groupcast transmissions on SL, hybrid automatic repeat request (“HARQ”) feedback, and HARQ combining in the physical layer of the UE are supported.

Both the LTE SL and the NR SL can operate with and without network coverage and with varying degrees of interaction between the UEs (user equipments) and the network, including support for standalone, network-less operation.

The SL can be configured on a dedicated carrier (e.g., in a carrier of an intelligent transport system (“ITS”) band or a band specified for SL) or on a carrier of the serving cell of the UE. In the latter case, the SL resources and resources for wireless access network (“WAN”) or cellular communication (over uplink or downlink, also known as Uu link) are shared in time and/or frequency. Typically, the SL resources are time multiplexed with the uplink resources used for cellular communication on the serving cell of the UE.

Similar as for ProSe in LTE, NR sidelink transmissions have the following two modes of resource allocations: 1) Sidelink resources are scheduled by a network node (e.g., gNB); and 2) The UE autonomously selects sidelink resources from a (pre-) configured sidelink resource pool(s) based on the channel sensing mechanism.

The in-coverage UE can be configured by a network node (e.g., gNB) to use Mode 1 or Mode 2 resource allocation mechanism. The out-of-coverage UE can only use Mode 2 resource allocation mechanism.

There currently exist certain challenges.

### SUMMARY

A sidelink (“SL”) user equipment (“UE”) (also referred to herein as a communication device) acquires its timing by synchronizing with respect to a synchronization source, which is generally called a synchronization reference source. The SL UE can be synchronized to any one of the pluralities of synchronization reference source including a global navigation satellite system (“GNSS”), a base station (e.g., gNB, or eNB), another SL UE synchronized to a GNSS or to a base station, or another UE (e.g., own clock). The SL UE selects its synchronization reference source based on priority levels. The synchronization reference source used by the SL UE can also change over time, for example, from GNSS to a SL UE or vice versa. The synchronization reference source change can happen due to many reasons such as mobility, link quality changes, change in the synchronization priorities, the current synchronization reference source becomes non-available (or unavailable), network configuration (e.g., the network can allow or not allow an SL UE to be a synchronization reference source). The impact of the change of the synchronization reference source while the SL UE is performing an SL measurement (e.g. SL positioning measurement) on the SL measurement performance (e.g. SL positioning measurement performance) is unknown.

The SL measurement (e.g. SL positioning measurement) involves a new measurement procedure. Therefore, several aspects are undefined and unknown. Various embodiments herein are directed to defining the SL UE behavior and the corresponding SL measurement procedure (e.g. SL positioning measurement procedure) when the synchronization reference source of the SL UE changes.

Certain aspects of the disclosure and their embodiments may provide solutions to these or other challenges.

Accordingly, in one aspect, there is provided method of operating a first communication device in a communications network that includes a second communication device. The method comprises receiving a first sidelink (SL) reference signal (RS) from the second communication device. The method comprises determining that a synchronization reference source has changed or is expected to change from a first synchronization reference source to a second synchronization reference source at one or both of the first communication device and the second communication device prior to completing an SL measurement procedure on the first SL RS. The method comprises controlling operation of the first communication device based on determining that the synchronization reference source has changed or is expected to change from the first synchronization reference source to the second synchronization reference source.

In another aspect, there is provided a first communication device comprising processing circuitry configured to cause the first communication device to receive a first SL RS, from a second communication device, determine that a synchronization reference source has changed or is expected to change from a first synchronization reference source to a second synchronization reference source at one or both of the first communication device and the second communication device prior to completing an SL measurement procedure on the first SL RS, and control operation of the first communication device based on determining that the synchronization reference source has changed or is expected to change from the first synchronization reference source to the second synchronization reference source.

In another aspect, there is provided a computer program comprising program code to be executed by processing circuitry of a first communication device, whereby execution of the program code causes the first communication device to perform the method described earlier.

In another aspect, there is provided a computer program product comprising a non-transitory storage medium including program code to be executed by processing circuitry of a first communication device, whereby execution of the program code causes the first communication device to perform the method described earlier.

In another aspect, there is provided a non-transitory computer-readable medium having instructions stored therein that are executable by processing circuitry of a first communication device to cause the first communication device to perform the method described earlier.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 is a schematic diagram illustrating an example of a 5G network;

FIG. 2 is a block diagram illustrating an example of NR architecture;

FIG. 3 is a block diagram illustrating a method according to an embodiment;

FIGS. 4A-C are schematic diagrams illustrating examples of a first UE engaging in SL positioning measurements in accordance with some embodiments;

FIGS. 5A-C are schematic diagrams illustrating examples of a first UE engaging in SL positioning measurements in accordance with some embodiments;

FIG. 6 is a flow chart illustrating an example of operations performed by a communication device in accordance with some embodiments;

FIG. 7 is a block diagram of a communication system in accordance with some embodiments;

FIG. 8 is a block diagram of a user equipment in accordance with some embodiments;

FIG. 9 is a block diagram of a network node in accordance with some embodiments;

FIG. 10 is a block diagram of a host computer communicating with a user equipment in accordance with some embodiments;

FIG. 11 is a block diagram of a virtualization environment in accordance with some embodiments;

FIG. 12 is a block diagram of a host computer communicating via a base station with a user equipment over a partially wireless connection in accordance with some embodiments in accordance with some embodiments;

FIGS. 13 and 14 illustrate some example extended LPP session procedures;

FIG. 15 illustrates an example protocol stack;

FIG. 16 illustrates an example of a ranging session; and

FIGS. 17 and 18 illustrate examples of overhearing.

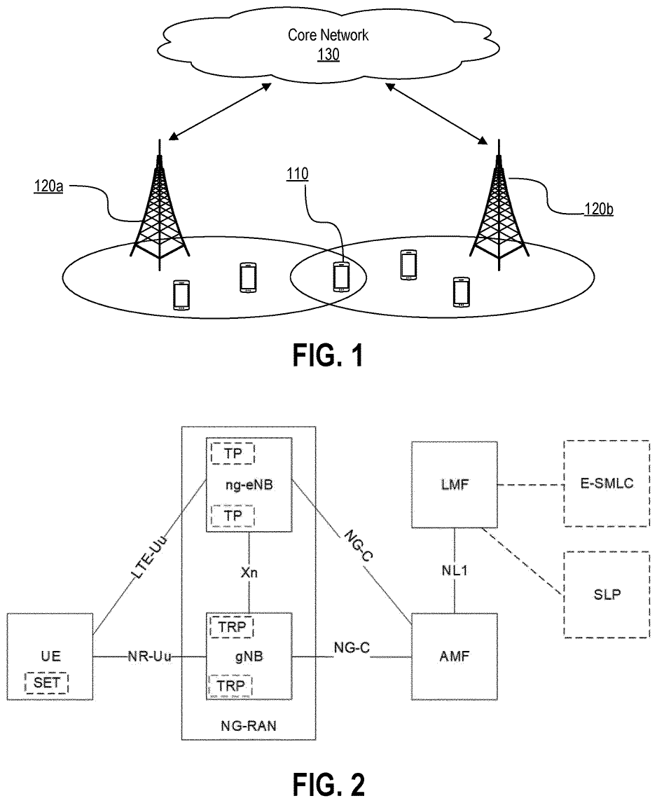

### DETAILED DESCRIPTION

Some of the embodiments contemplated herein will now be described more fully with reference to the accompanying drawings. Embodiments are provided by way of example to convey the scope of the subject matter to those skilled in the art, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

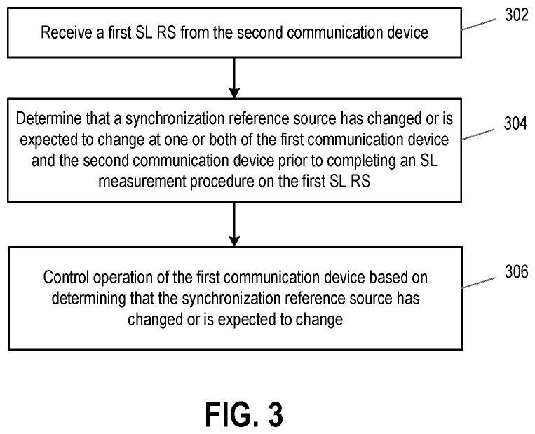

FIG. 3 illustrates a first method according to an aspect of the disclosure. The first method is a method of operating a first communication device in a communications network that includes a second communication device.

As illustrated by block 302, the first method comprises receiving a first sidelink (SL) reference signal (RS) from the second communication device. As illustrated by block 304, the first method comprises determining that a synchronization reference source has changed or is expected to change from a first synchronization reference source to a second synchronization reference source at one or both of the first communication device and the second communication device prior to completing an SL measurement procedure on the first SL RS. As illustrated by block 306, the first method comprises controlling operation of the first communication device based on determining that the synchronization reference source has changed or is expected to change from the first synchronization reference source to the second synchronization reference source.

In some embodiments, the RS may be a positioning RS (PRS).

In some embodiments, the SL measurement procedure may be an SL positioning measurement procedure.

In some embodiments, the SL measurement procedure may comprise performing an SL measurement over a measurement period.

In some embodiments, controlling the operation of the first communication device may comprise controlling the SL measurement procedure.

In some embodiments, controlling the SL measurement procedure may comprise at least one of: restarting the SL measurement procedure, continuing the SL measurement procedure; stopping the SL measurement procedure, suspending the SL measurement procedure, restarting a measurement period associated with the SL measurement procedure, and extending a measurement period associated with the SL measurement procedure.

In some embodiments, controlling the SL measurement procedure may comprise controlling the SL measurement procedure based on a type of the SL measurement procedure.

In some embodiments, controlling the SL measurement procedure based on a type of the SL measurement procedure may comprise determining to restart the SL measurement procedure based on the SL measurement procedure including a timing related SL positioning measurement. In some embodiments, the timing related SL positioning measurement may comprise at least one of: a timing related SL positioning measurement on at least a signal transmitted by the second communication device, a timing related SL positioning measurement on a signal transmitted by the second communication device and a signal received by the first communication device from the second communication device, and a measurement on a signal transmitted by the first communication device.

In some embodiments, controlling the SL measurement procedure based on a type of the SL measurement procedure may comprise determining to continue the SL measurement procedure based on the SL measurement procedure including at least one of: a measurement performed by the first communication device on a signal received from the second communication device, a measurement performed by the first communication device on signals received from the second communication device and a third communication device, and a measurement associated with an angle of arrival (AoA).

In some embodiments, controlling the SL measurement procedure may comprise discarding measurements obtained while using the first synchronization reference source.

In some embodiments, determining that the synchronization reference source has changed or is expected to change from the first synchronization reference source to the second synchronization reference source may comprise determining that the synchronization reference source has changed or is expected to change from the first synchronization reference source to the second synchronization reference source prior to initiating the SL measurement procedure, wherein controlling the SL measurement procedure may comprise delaying the SL measurement procedure until after the synchronization reference source has changed from the first synchronization reference source to the second synchronization reference source.

In some embodiments, the first method may comprise initiating the SL measurement procedure prior to initiating a synchronization reference source change procedure, wherein controlling operation of the first communication device may comprise controlling a synchronization reference source procedure based on initiating the SL measurement procedure prior to initiating the synchronization reference source change procedure.

In some embodiments, controlling the synchronization reference source procedure may comprise at least one of: canceling the change from the first synchronization reference source to the second synchronization reference source, delaying the change from the first synchronization reference source to the second synchronization reference source, and changing from the first synchronization reference source to a third synchronization reference source.

In some embodiments, controlling the synchronization reference source procedure may comprise controlling the synchronization reference source procedure based on at least one of: a type of the first synchronization reference source and a type of the second synchronization reference source.

In some embodiments, controlling the operation of the first communication device may comprise controlling the operation of the first communication device based on the first communication device and the second communication device sharing a common synchronization reference source.

In some embodiments, determining that the synchronization reference source has changed or is expected to change from the first synchronization reference source to the second synchronization reference source may comprise measuring a received signal level (RSL) from the first synchronization reference source and determining that the synchronization reference source is expected to change from the first synchronization reference source to the second synchronization reference source based on a comparison of the RSL and a threshold value.

In some embodiments, determining that the synchronization reference source has changed or is expected to change from the first synchronization reference source to the second synchronization reference source may comprise receiving a message from an entity in the communications network, the message indicating that the synchronization reference source has changed or is expected to change from the first synchronization reference source to the second synchronization reference source. In some embodiments, the entity may comprise at least one of: a network node, the second communication device, and a third communication device.

In some embodiments, determining that the synchronization reference source has changed or is expected to change from the first synchronization reference source to the second synchronization reference source may comprise determining that the synchronization reference source has changed from the first synchronization reference source to the second synchronization reference source.

In some embodiments, the first method may comprise receiving a second SL RS from the second communication device or from a third communication device. In some embodiments, the first method may comprise transmitting a second SL RS to the second communication device or to the third communication device after executing the controlling operation and completing the SL measurement procedure on the second SL RS.

In some embodiments, the first method may comprise transmitting a message to an entity, the message including at least one of: an indication of a change to the operation of the first communication device and an indication of a result of the SL measurement procedure.

In some embodiments, the first method may comprise performing synchronization of the first communication device based on a result of the SL measurement procedure.

In some embodiments, the first method may comprise enhancing a range estimation based on a result of the SL measurement procedure.

In some embodiments, the SL measurement procedure may comprise one or more of: an SL reception-transmission (Rx-Tx) time difference measurement procedure, an SL reference signal time difference (RSTD) measurement procedure, an SL reference signal received power (RSRP) measurement procedure, an SL reference signal received path power (RSRPP) measurement procedure, an SL relative time of arrival (RTOA) measurement procedure, an SL azimuth angle of arrival (AoA) measurement procedure, and an SL zenith angle of arrival (ZoA) measurement procedure.

There is also provided a first communication device comprising processing circuitry configured to cause the first communication device to perform the first method described earlier.

There is also provided a computer program comprising program code to be executed by processing circuitry of a first communication device, whereby execution of the program code causes the first communication device to perform the first method described earlier.

There is also provided a computer program product comprising a non-transitory storage medium including program code to be executed by processing circuitry of a first communication device, whereby execution of the program code causes the first communication device to perform the first method described earlier.

There is also provided a non-transitory computer-readable medium having instructions stored therein that are executable by processing circuitry of a first communication device to cause the first communication device to perform the first method described earlier.

In some embodiments, a first SL UE (which may be referred to herein as UE1), may determine a need to change its synchronization reference source status while performing a SL measurement (e.g. SL positioning measurement) on a reference signal (e.g., an SL positioning reference signal, SL PRS) transmitted on an SL between UE1 and at least a second SL UE (which may be referred to as UE2). In additional or alternative embodiments, the first SL UE may adapt one or more procedures related to the synchronization reference source status and/or adapt one or more SL measurement procedures (e.g. SL positioning measurement procedures) upon determining the need to change its synchronization reference source status (e.g., from a first synchronization reference source (which may be referred to as SYRS1) status to a second synchronization reference source (which may be referred to as SYRS2) status).

In additional or alternative embodiments, changing synchronization reference source status may include changing, transition, or reselecting the synchronization reference source for own SL operation, changing between being and not being a synchronization reference source for others.

In additional or alternative embodiments, UE1 may determine the need to change its synchronization reference source based on one or more triggering conditions (e.g., when SYRS1 is not detectable anymore) when a received signal level of SYRS1 is below a certain threshold, upon receiving a message or command from another node (e.g., a network node, or another UE).

Examples of the adaptation of the synchronization reference source related procedures performed by UE1 are postponing the change of the synchronization reference source, cancelling the change of the synchronization reference source or selectively changing the synchronization reference source.

Examples of the adaptation of the SL measurement (e.g. SL positioning measurement) related procedures performed by UE1 are restarting, continuing or stopping performing the SL measurement (e.g. SL positioning measurement). The one or more SL measurement procedures (e.g. SL positioning measurement procedures) are adapted if UE1 changes its synchronization reference source (e.g. from SYRS1 to SYRS2) at least once during the SL measurement period (e.g. SL positioning measurement period).

In additional or alternative embodiments, UE1 may further use the results of the adaptation for one or more operational tasks e.g. transmitting the results of the adaption to another node (e.g., another UE or a network node), using the results for enhancing the synchronization.

In additional or alternative embodiments, the target SL UE while performing a SL measurement (e.g. SL positioning measurement) on SL RS (e.g., SL PRS) upon changing its synchronization reference source status, may adapt the SL measurement procedure (e.g. SL positioning measurement procedure). Alternatively, the target SL UE while performing a SL measurement (e.g. SL positioning measurement) on SL RS (e.g., SL PRS) may postpone or cancel changing its synchronization reference source status. The adaptation allows, for example, to avoid or minimize the degradation of the SL measurement performance (e.g. SL positioning measurement performance).

According to some embodiments, a method of operating a first communication device in a communications network that includes a second communication device is provided. The method may include communicating an SL RS with the second communication device. The method includes determining that the first communication device has changed or is expected to change from a first synchronization reference source to a second synchronization reference source prior to completing a SL measurement procedure based on the SL RS. The method includes controlling (e.g. adjusting) operation of the first communication device based on determining that the first communication device has changed or is expected to change from the first synchronization reference source to the second synchronization reference source.

According to other embodiments, a communication device, network node, computer program, computer program product, system, host, or non-transitory computer readable medium is provided and configured to perform any one or more of the above actions.

Certain embodiments may provide one or more of the following technical advantages. In some embodiments, UE behavior in terms of the SL measurement procedure (e.g. SL positioning measurement procedure) when synchronization reference source changes is predictable, consistent and well defined.

In additional or alternative embodiments, the UE is able to perform SL measurements (e.g. SL positioning measurements) even when the synchronization reference source changes.

In additional or alternative embodiments, the SL positioning measurement performance is enhanced while the synchronization reference source changes during the SL positioning measurement period. This in turn enhances the UE positioning accuracy as it relies on the SL positioning measurement.

Additional information may also be found in the document(s) provided in the Appendices.

The embodiments described herein are applicable for any type of D2D operation (e.g., ProSe and V2X).

An SL positioning measurement performed by a target UE can be used for determining position or location of that target UE. The target UE can perform an SL positioning measurement on SL reference signals (e.g., SL PRS) transmitted by one or more anchor UEs and/or on SL reference signals (e.g., SL PRS) transmitted by the target UE itself.

Examples of the SL positioning measurements include: SL Reception (“Rx”)-Transmission (“Tx”) time difference measurements; SL reference signal time difference (“RSTD”) measurements; SL reference signal received power (“RSRP”) measurements; SL reference signal received path power (“RSRPP”) measurements; SL relative time of arrival (“RTOA”) measurements; SL azimuth angle of arrival (“AoA”) measurements; and SL zenith angle of arrival (“ZoA”) measurements.

SL Rx-Tx time difference measurements can be defined as T_{SL-RX}−T_{SL-TX}. It may also be referred to as a round trip time (“RTT”) measurement. T_{SL-RX} is the received timing of an SL time resource #i (e.g., subframe #i) from an anchor UE, defined by the first detected path in time. It can be measured by the target UE on SL PRS signals received from the anchor UE. T_{SL-TX} is the transmit timing of the SL time resource #j (e.g., subframe #j) that is closest in time to the time resource #i (e.g., subframe #i) received from the anchor UE. It can be measured on SL PRS signals transmitted by the target UE.

SL RSTD measurements can be defined as reference signal time differences between two anchor UEs (e.g., between an anchor UE i and a reference anchor UE j). It can be measured by the target UE on SL PRS signals transmitted by the anchor UE i and the reference anchor UE j.

SL RSRP measurements can be defined as the linear average over the power contributions (in [W]) of the resource elements that carry SL PRS reference signals. It is measured by the target UE on the SL PRS transmitted by the anchor UE.

SL RSRPP measurements can be defined as the linear average of the channel response at the i-the path delay of the of the resource elements that carry SL PRS reference signals. SL RSRPP for the 1st path delay is the power contribution corresponding to the first detected path in time. It can be measured by the target UE on the SL PRS transmitted by the anchor UE.

SL RTOA measurements can be defined as the beginning of SL time resource #i (e.g., subframe #i) including SL PRS received in the target UE, relative to a reference time (e.g., the RTOA Reference Time).

SL AoA measurements can be defined as the Azimuth angle of Arrival of the SL PRS transmitted by the anchor UE. It is measured by the target UE.

SL ZoA measurements can be defined as the Zenith angle of Arrival of the SL PRS transmitted by the anchor UE. It is measured by the target UE.

An SL positioning reference signal (“PRS”) can be similar to or identical to a downlink (“DL”) PRS used for positioning measurement in the WAN (e.g., on Uu interface). The numerologies of the SL PRS may be limited to those defined for SL operation.

SL PRS may be periodically transmitted on a carrier frequency (e.g., SL positioning frequency layer) in PRS resources on the SL by a SL UE. SL PRS can include PRS resource sets, where each PRS resource set includes one or more PRS resources. All the SL PRS resources within one PRS resource set may be configured with the same periodicity. The PRS resource periodicity (Tₚₑᵣ^{PRS}) can include: Tₚₑᵣ^{PRS}∈2^{μ}{4, 8, 16, 32, 64, 5, 10, 20, 40, 80, 160, 320, 640, 1280, 2560, 5120, 10240, 20480} slots, where μ=0, 1, 2, 3 for PRS SCS of 15, 30, 60 and 120 kHz respectively. Tₚₑᵣ^{PRS}=2^{μ}·20480 is not supported for μ=0.

Each PRS resource can also be repeated within one PRS resource set and takes values Tₚₑᵣ^{PBS}∈{1,2,4,6,8,16,32}.

PRS may be transmitted in consecutive number of symbols (L_{PRS}) within a slot: L_{PRS}∈{2,4,6,12}. The following PRS RE patterns, with comb size K_{PRS} equal to number of symbols L_{PRS} are supported: 1) Comb-2: Symbols {0, 1} have relative RE offsets {0, 1}; 2) Comb-4: Symbols {0, 1, 2, 3} have relative RE offsets {0, 2, 1, 3}; 3) Comb-6: Symbols {0, 1, 2, 3, 4, 5} have relative RE offsets {0, 3, 1, 4, 2, 5}; and 4) Comb-12: Symbols {0, 1, 2, 3, 4, 5, 6, 7, 8, 9, 10, 11} have relative RE offsets {0,6,3,9,1,7,4, 10,2,8,5,11}.

Maximum PRS bandwidth (BW) can be 272 PRBs. Minimum PRS BW can be 24 PRBs. The configured PRS BW may (e.g. always) be a multiple of 4.

The PRS resource set may include parameters such as subcarrier spacing (“SCS”), PRS BW, PRS resource set periodicity and slot offset with regards to reference time (e.g., slot #0), PRS resource repetition factor (e.g., number of times PRS resource repeated in a PRS resource set), PRS symbols in PRS resource, PRS resource time gap (e.g., number of slots between successive repetitions), and PRS muting pattern.

Examples of physical channels and reference signals for SL operation NR (available in LTE) include: a physical sidelink shared channel (“PSSCH”); a physical sidelink feedback channel (“PSFCH”); a physical sidelink common control channel (“PSCCH”); a sidelink primary synchronization signal (“S-PSS”); a sideling secondary synchronization signal (“S-SSS”); a physical sidelink broadcast channel (“PSBCH”); a demodulation reference signal phase tracking reference signal (“PT-RS”); a channel state information reference signal (“CSIRS”); and a sidelink positioning reference signal (“SL-PRS”).

PSSCH is an SL version of a physical downlink shared channel (“PDSCH”). The PSSCH may be transmitted by a sidelink transmitter UE, which can convey sidelink transmission data, system information blocks (“SIBs”) for RRC configuration, and a part of the sidelink control information (“SCI”) (e.g., a SL version of downlink control information (“DCI”)).

The PSFCH may be transmitted by a sidelink receiver UE for unicast and groupcast, which can convey 1 bit information over 1 resource block (“RB”) for a HARQ acknowledgement (“ACK”) and a negative ACK (“NACK”). In addition, channel state information (“CSI”) may be carried in the medium access control (“MAC”) control element (“CE”) over the PSSCH instead of the PSFCH.

PSCCH is an SL version of a physical downlink control channel (“PDCCH”). When the traffic to be sent to a receiver UE arrives at a transmitter UE, a transmitter UE may first send the PSCCH, which can convey a part of SCI to be decoded by any UE, e.g. for channel sensing purpose, such as including the reserved time-frequency resources for transmissions, demodulation reference signal (“DMR”S) pattern and antenna port.

S-PSS/S-SSS are similar to downlink transmissions in NR, in sidelink transmissions, primary and secondary synchronization signals (called S-PSS and S-SSS, respectively) are supported. Through detecting the S-PSS and S-SSS, a UE is able to identify the sidelink synchronization identity (“SSID”) from the UE sending the S-PSS/S-SSS. Through detecting the S-PSS/S-SSS, a UE is therefore able to know the characteristics of the UE transmitter the S-PSS/S-SSS. A series of processes of acquiring timing and frequency synchronization together with SSIDs of UEs is called initial cell search. Note that the UE sending the S-PSS/S-SSS may not be necessarily involved in sidelink transmissions, and a node (UE/eNB/gNB) sending the S-PSS/S-SSS is called a synchronization source. There can be 2 S-PSS sequences and 336 S-SSS sequences forming a total of 672 SSIDs in a cell.

The PSBCH may be transmitted along with the S-PSS/S-SSS as a synchronization signal or PSBCH block (“SSB”). The SSB can have the same numerology as PSCCH/PSSCH on that carrier, and an SSB may be transmitted within the bandwidth of the configured bandwidth part (“BWP”). The PSBCH can convey information related to synchronization, such as the direct frame number (“DFN”), indication of the slot and symbol level time resources for sidelink transmissions, in-coverage indicator. The SSB may be transmitted periodically every 160 ms.

PT-RS and CSIRS are physical reference signals supported by NR downlink/uplink transmissions that are also adopted by sidelink transmissions. Similarly, the PT-RS may only be applicable for frequency range 2 (“FR2”) transmission.

SL-PRS is a reference signal transmitted by a SL UE that is used by another SL UE for performing SL positioning measurements. The SL-PRS is analogous to a downlink (DL) Positioning Reference Signal (PRS) used for performing positioning measurements by a base station or UE in WAN (e.g., over a Uu link).

In some embodiments herein, the term network node is used to refer to a NodeB, a base station (“BS”), a multi-standard radio (“MSR”) radio node such as a MSR BS, an eNodeB, a gNodeB, a master eNB (“MeNB”), a secondary eNB (“SeNB”), a location measurement unit (“LMU”), an integrated access backhaul (“IAB”) node, a network controller, a radio network controller (“RNC”), a base station controller (“BSC”), a relay, a donor node controlling relay, a base transceiver station (“BTS”), a Central Unit (e.g., in a gNB), a Distributed Unit (e.g., in a gNB), a Baseband Unit, a Centralized Baseband, a C-RAN, an access point (“AP”), transmission points, transmission nodes, a transmission reception point (“TRP”), a remote radio unit (RRU), a remote radio head (RRH), nodes in distributed antenna system (“DAS”), a core network node (e.g., Mobile Switching Center (MSC) or Mobility Management Entity (MME)), an Operation and Maintenance (O&M), an Operations Support System (OSS), a Self-Optimized Network (SON), a positioning node (e.g., Evolved-Serving Mobile Location Centre (E-SMLC)), an LMF, or an Access and Mobility Management Function (AMF).

In additional or alternative embodiments, the term communication device can be used to refer to any type of wireless device communicating with a network node and/or with another communication device in a cellular or mobile communication system. Examples of a communication device include a UE, a target device, a device to device (“D2D”) UE, a vehicular-to-vehicular (“V2V”), a machine type UE, a MTC UE, a UE capable of machine to machine (“M2M”) communication, a PDA, a tablet, a mobile terminal, a smart phone, a laptop embedded equipment (“LEE”), a laptop mounted equipment (“LME”), a USB dongle.

In additional or alternative embodiments, the term radio access technology (“RAT”) may refer to any RAT. For example, RAT may refer to Universal Mobile Telecommunications System Terrestrial Radio Access (UTRA), Evolved UTRA (E-UTRA), narrow band internet of things (“NB-IoT”), WiFi, Bluetooth, next generation RAT, New Radio (“NR”), fourth generation (4G), or fifth generation (5G). Any of the equipment denoted by the term node, network node, or radio network node may be capable of supporting a single or multiple RATs.

In additional or alternative embodiments, the term time resource used herein may correspond to any type of physical resource or radio resource expressed in terms of length of time. Examples of time resources are: symbol, time slot, subframe, radio frame, Transmission Time Interval (TTI), interleaving time, slot, sub-slot, mini-slot, system frame number (“SFN”), and hyper SFN (“H-SFN”).

In additional or alternative embodiments, the term sidelink reference signal (“SLRS” or “SL RS”) used in the embodiments can refer to any type of RS which can be transmitted by a UE on a SL. Examples of such RS are SL PRS, SL Secondary Synchronization Signal Block (SL-SSSB), sidelink synchronization signal (SLSS), S-PSS, S-SSS, PSBCH or any combination (e.g., S-SS/PSBCH (S-SS+S-PSS+PSBCH).

In additional or alternative embodiments, a SL positioning measurement can refer to a measurement performed on at least one sidelink and the measurement result can be used for positioning purpose; such measurement can be unidirectional or bidirectional, absolute or relative (e.g., with respect to a reference or another measurement); such measurement can be a timing measurement (e.g., Rx-Tx time difference, RTT, TOA, RSTD, RTOA, etc.), received power measurement (e.g., RSRP, RSRPP), angle measurement (e.g., AoA, ZoA, Difference of Arrival (DoA)), received signal quality measurement (e.g., RSRP, Signal to Interference & Noise Ratio (SINR), reference symbol/signal received quality (RSRQ)).

The disclosure relates to wireless communication systems. The disclosure also relates to an SL measurement procedure, such as an SL positioning measurement procedure, e.g. during a synchronization source change. In some examples, a first SL capable UE (UE1) may be configured to perform at least one SL measurement (e.g. SL positioning measurement) on at least one SL reference signal (“RS”) (e.g., a SL positioning reference signal (“PRS”)) transmitted on an SL between UE1 and a second SL capable UE (UE2). UE1 may be referred to as a target UE as it is performing the SL measurement (e.g. SL positioning measurement) on at least the SL RS transmitted by UE2. UE2 may be referred to as an anchor UE as it is assisting UE1 in performing the SL measurement (e.g. SL positioning measurement) (e.g., by transmitting the SL RS on the SL). UE1 may be configured to perform the SL measurement (e.g. SL positioning measurement) autonomously or by receiving a request from another node. In some examples, the other nodes can be another UE, a network node (e.g., a serving BS or a core network node), a location server (e.g., positioning node, AMF, LMF, Serving Mobile Location Centre (SMLC), or E-SMLC).

In additional or alternative examples, the SL measurement (e.g. SL positioning measurement) may be performed by UE1 only on a second SL RS (RS2) transmitted by UE2 (e.g., SL AoA, SL RSRP, SL RSRPP, SL Time of Arrival (TOA), or SL RTOA). In additional or alternative examples, the SL measurement (e.g. SL positioning measurement) may be performed by UE1 involving a first SL RS (RS1) transmitted by UE1 (itself) and RS2 transmitted by UE2 (e.g., SL UE Rx-Tx time difference, SL timing advance (“TA”)). In additional or alternative examples, the SL measurement (e.g. SL positioning measurement) may be performed by UE1 involving SL RS transmitted by at least two different anchor UEs (e.g., on RS2 transmitted by UE2 and a third SL RS (RS3) transmitted by a third SL capable UE (UE3)). An example of such measurement is SL RSTD. Examples of RS1, RS2, and RS3 are a first SL PRS (PRS1) transmitted by UE1, a second SL PRS (PRS2) transmitted by UE2, and a third SL PRS (PRS3) transmitted by UE3, respectively. UE1 may operate: RS2 with regards to UE2 on a second carrier frequency (F2) and RS3 with regards to UE3 on a third carrier frequency (F3). UE1 may transmit RS1 on F2 or on F3 or on a fourth carrier frequency (F4). In some examples, F2 and F3 may be the same carrier frequency. In other examples, F2 and F3 may be different carrier frequencies.

UE1 may be further synchronized to or obtain at least timing synchronization from a first synchronization reference source (SYRS1). The synchronization reference source status of UE1 can include one or more of: synchronization reference for UE1 operation, synchronization reference for UE1 positioning operation, the UE1 itself provided it is a synchronization reference for one or more other UEs, and the UE1 itself provided it is a synchronization reference for positioning operation.

UE1 may obtain the synchronization based on a reference signal (RS) received from SYRS1 on a first carrier frequency (F1). UE1 may use the obtained timing from SYRS1 for performing one or more operations (e.g., transmitting SL signals according to the obtained timing). SYRS1 can be a global navigation satellite system (“GNSS”) source/node, another SL UE (e.g., SyncRef UE within or outside network (NW) coverage), a network node (e.g., a base station such as gNB or eNB), or its own internal clock. Examples of the GNSS include global positioning system (GPS), Galileo, Globalnaya Navigazionnaya Sputnikovaya Sistema (GLONASS), BeiDou, Indian Regional Navigation Satellite System (IRNSS), and Quasi-Zenith Satellite System (QZSS). UE1 may determine and select a synchronization reference source based on one or more rules, which can be pre-defined or configured by a network node (e.g., a serving BS) or pre-configured in UE1 (e.g., in a Subscriber Identity Module or Universal Subscriber Identity Module (SIM/USIM) card). The one or more rules enable UE1 to determine priority of different types of synchronization reference source (e.g., GNSS is higher priority than a network node), which in turn is of higher priority than a syncRef UE. Another rule may be that among candidate synchronization reference sources with the same priority level, the SL selects the one with the highest RSRP. In general, changing synchronization reference source status may include any of: 1) changing to another synchronization reference source; 2) transitioning of the synchronization reference source; 3) selecting a new synchronization reference source or reselection of a synchronization reference source for own SL operation; 4) changing from being to not being a synchronization reference source for one, two, or more other UEs; 5) changing from not being to being a synchronization reference source for one, two, or more other UEs; 6) starting or stopping transmitting radio signals used for synchronization by one, two or more UEs; 7) changing from synchronization reference source status non-applicable, not associated with, or which cannot be used for positioning to synchronization reference source status applicable, associated with, or which can be used for positioning; and/or 8) changing from synchronization reference source status applicable, associated with, or which can be used for positioning to synchronization reference source status non-applicable, not associated with, or which cannot be used for positioning.

To become a SynchRef, UE, an SL UE: (1) can be configured by the network (for in-coverage), or (2) can decide on its own (for in or out of network coverage) based on the RSRP for the serving cell or for the current SynchRef UE (RSRP below a threshold is a trigger for an SL UE to become a SynchRef and transmit S-SSB), or (3) can decide on its own if it uses internal clock as SynchRef.

Any of the UEs (e.g. UE1, UE2, UE3, SyncRef UE etc) involved in the SL measurement (e.g. SL positioning measurement) or acting as sync source may operate in any type of coverage mode e.g. in-network coverage (INC), partial network coverage (PNC) or out of network coverage (ONC).

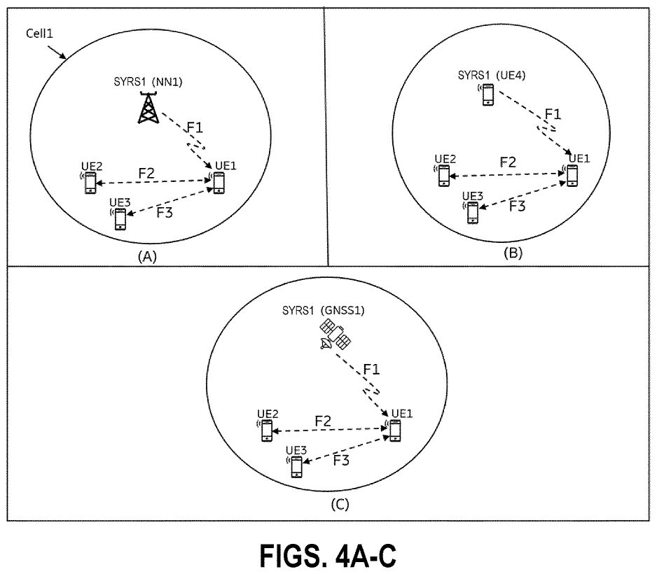

FIGS. 4A-C illustrate a scenario considered in some of the embodiments. FIGS. 4A-C illustrate that UE1 is engaged in an SL measurement (e.g. SL positioning measurement) with UE2 on F2 and/or with UE3 on F3. UE1 obtains the time synchronization with regards to a first synchronization reference sources (SYRS1) operating on F1. FIG. 4A illustrates an example in which SYRS1 is a first network node (NN1) (e.g., a base station, an eNB, a gNB, and an access point). FIG. 4B illustrates an example in which SYRS1 is another UE (e.g., a fourth UE (UE4)). UE4 is also referred to as a SyncRef UE. In some embodiments, F1 and the other carriers (e.g., F2 and F3) may be different carrier frequencies operating on the same or different frequency bands. In some embodiments, F1 and one or more of the other carriers (e.g., F2 and F3) may be the same carrier frequencies (e.g., F1=F2, F1=3, or F1=F2=F3). In the latter, the radio links (or signals) between UE1 and UE2/UE3, and between UE1 and SYRS1 may be orthogonal with regards to each other in time domain and/or in frequency domain. FIG. 4C illustrates an example in which SYRS1 is a GNSS (GNSS1).

Various embodiments herein provide operations to be performed by a target UE (UE1) that is configured to perform at least one SL measurement (e.g. SL positioning measurement).

In some embodiments, UE1 may determine a need to change its synchronization reference source status (SYRS1) while or during a time period (e.g., a measurement period) when UE1 is performing at least one SL measurement (e.g. SL positioning measurement).

In additional or alternative embodiments, UE1 may adapt at least one of the following set of procedures: 1) A first set of one or more procedures related to or involving SYRS1; and 2) A second set of one or more procedures related to the at least one SL measurement (e.g. SL positioning measurement).

In additional or alternative embodiments, UE1 may further use the results or outcome of the adaptation related to the first set of the procedures and/or the second set of the procedures for performing one or more operational tasks. In some examples, the tasks may include transmitting the results to another node (e.g., another UE or a network node). UE1 may use the results of the SL measurement (e.g. SL positioning measurement) performed by UE1 for one or more operational tasks (e.g., determining UE1 positioning or transmitting the results to another node).

Embodiments associated with determining the need to change SYRS1 status are described below.

In some embodiments, UE1 can be triggered to change its synchronization reference source status (SYRS1) to another synchronization reference source status based on one or more rules or criteria, which can be pre-defined or configured by a network node or autonomously determined by UE1. Examples of the criteria that can trigger UE1 to change its synchronization reference source status are any one or more of the following examples.

In some examples, UE1 may be triggered to change SYRS1 status if the received signal level (“RSL”) measured by UE1 on an RS (e.g., SL RS, SSB, Channel state information reference signals (CSI-RS), or RS used for positioning via SL) transmitted by SYRS1 falls below a certain threshold. Examples of the RSL are received signal strength (“RSS”) and received signal quality (“RSQ”). Examples of RSS are path loss, RSRP, etc. Examples of RSQ are Signal to Noise Ratio (SNR), SINR, RSRQ, RS Ês/Iot etc. Ês is the received energy per Resource Element (RE) (power normalized to the subcarrier spacing) during the useful part of the symbol, i.e. excluding the cyclic prefix, at the UE antenna connector or radiated interface boundary. Iot is the received power spectral density of the total noise and interference for a certain RE (power integrated over the RE and normalized to the subcarrier spacing) as measured at the UE antenna connector or radiated interface boundary. UE1 can be triggered to change SYRS1 status if the RSL measured by UE1 on a RS (e.g., SLRS, SSB, CSI-RS, RS used for positioning via SL) transmitted by SYRS1 remains below a certain threshold for at least X1 time or for a time longer than X2.

In additional or alternative examples, UE1 may be triggered to change SYRS1 status if SYRS1 is not detectable anymore for UE1. SYRS1 may not be detectable if UE1 cannot receive the signals of SYRS1 (e.g., from GNSS source). Alternatively, SYRS1 may not be considered detectable for UE1 if it meets one or more detectable conditions for SYRS1; otherwise SYRS1 is not considered to be detectable. Examples of the detectable conditions are RSL (e.g., PSBCH-RSRP) of a channel (e.g., PSBCH, physical broadcast channel (PBCH)) is above a threshold for the frequency band of F1, RSL, and RSQ of an RS (e.g., SLRS, SSB, CSI-RS, SL positioning reference signal) are above their respective thresholds for the frequency band of F1. UE1 can be triggered to change SYRS1 status if SYRS1 is not detectable for UE1 for at least Y1 time or for a time longer than Y2.

In additional or alternative examples, UE1 may be triggered to change SYRS1 status if the timing error of the signals received by UE1 from SYRS1 is above a certain threshold (e.g., if the change in the reception timing of SYRS1 at UE1 is above a certain threshold).

In additional or alternative examples, UE1 may be triggered to change SYRS1 status based on an indication or message received from another node (e.g., from a network node or from another UE).

In additional or alternative examples, UE1 may be triggered to change SYRS1 status based on the outcome of radio link procedures (“RLP”) performed by UE1. Examples of RLP are radio link monitoring (“RLM”), a link recovery procedure (“LRP”), or a beam management procedure. The LRP further includes beam failure detection, candidate beam detection, or beam signal measurements (e.g., layer one reference signal received power (L1-RSRP), layer one signal to interference noise ratio (L1-SINR), etc.). The sidelink RLM can be performed based on the HARQ (e.g., based on NACK or absence of HARQ feedback) feedback at the transmitting node. For instance, UE1 may trigger a change of SYRS1 if the HARQ feedback shows a (e.g. frequent) need for retransmissions (e.g., if X out of N last transmitted packets require retransmissions). In one example, the sidelink RLM may be evaluated based on the Radio Link Control (RLC) retransmissions (e.g., maximum number of RLC retransmissions are used to indicate RLF at the transmitting node). In another specific example, the sidelink RLM may be evaluated based on the block error rate (“BLER”). For instance, UE1 may trigger a change of synchronization reference source if the observed BLER is higher than a certain threshold.

In additional or alternative examples, UE1 may be triggered to change its SYRS1 status upon determining that UE1 needs to transmit a positioning reference signal via an SL link.

In additional or alternative examples, UE1 may be triggered to change its SYRS1 status upon determining the need to join one or more other UEs for a common positioning session via an SL link or for an interaction (e.g., transmission and/or reception of one or more radio signal) for positioning purposes.

In additional or alternative examples, UE1 may be triggered to change its SYRS1 status upon determining that the time difference between the reception timing of a first radio signal transmission from a first SL UE and the reception timing of a second radio signal transmission from a second SL UE exceeds a threshold. The first and the second radio signals can be SL positioning reference signal or SL SSB. The first and the second SL UE can be the UEs which participate in the same positioning session.

In additional or alternative examples, UE1 may be triggered to change its SYRS1 status, based on a priority (priority can be determined, for example, based on a specific type of RS, coverage indicator, or reference signal identifier (ID)). In some examples, a new candidate SYRS2 may have a higher priority than SYRS1. In additional or alternative examples, the current SYRS1 may have changed its priority for synchronization reference (e.g., UE receives a new coverage indicator from SYRS1). In additional or alternative examples, a reference signal of a specific type (e.g., positioning reference signal or SL synchronization signal) may be detected with a specific ID or with an ID within a specific ID range (e.g., detecting SL synchronization signal with ID 0 or ID in range {1, . . . , 335} or detecting a positioning reference signal from a candidate SYRS2 with a specific ID indicative of the need to change from SYRS1 to SYRS2).

In additional or alternative examples, UE1 may be triggered to change its SYRS1 status (e.g., become or stop being a synchronization reference for one or more other UEs) upon determining one or more of: 1) its own priority as synchronization reference for one or more other UEs becomes higher or lower than a priority of another UE; 2) UE1 needs to become a positioning reference for one or more other UEs; 3) UE1 needs to transmit one or more signals for a bidirectional measurement with at least one other UE; and 4) UE1 becomes a common reference for two or more UE involved in the same positioning session.

In additional or alternative embodiments, UE1 upon determining that it has been triggered to change its synchronization reference source status (SYRS1) may adapt one or both of the following sets of the procedures based on one or more rules, which can be pre-defined or configured by a network node: 1) one or more procedures belonging to a first set, which are related to or involving SYRS1 status; and 2) one or more procedures belonging to a second set, which are related to one or more SL measurements (e.g. SL positioning measurements).

Rules for adapting the above sets of the procedures are described below with examples.

In some embodiments, UE1 may postpone a synchronization reference source status change during the SL measurement (e.g. SL positioning measurement) period. In one example of the rule, UE1 may postpone or delays changing the SYRS1 status. UE1 may postpone the changing of SYRS1 status. UE1 may postpone it for undefined time or for certain time period (T11) or until a certain high-priority procedure or measurement is completed (e.g., RLM, positioning measurement) or until an indication from another node (SL UE or network node) is received. T11 may be pre-defined or configured by another node (e.g., by a network node or another UE). In one example, T11 may correspond to or is larger than the measurement period of the ongoing SL measurement (e.g. SL positioning measurement). In another example, UE1 may postpone the changing of SYRS1 status provided that the ongoing SL measurement (e.g. SL positioning measurement) can be completed within certain time period (T12).

In additional or alternative embodiments, UE1 cancels synchronization reference source status change during an SL measurement (e.g. SL positioning measurement) period. In another example of the rule, UE1 cancels/discards changing the SYRS1 status. UE1 may apply this rule even though SYRS1 quality is below certain threshold but is still within acceptable level. UE1 may also apply this rule if the internal clock associated with the SYRS1 status can operate within certain accuracy (e.g. ±0.1 ppm) based on SYRS1 timing for certain time period e.g. during the SL measurement (e.g. SL positioning measurement) period.

In additional or alternative embodiments, UE1 may selectively change synchronization reference source status during an SL measurement (e.g. SL positioning measurement) period. In another example of the rule, UE1 may change SYRS1 status to only certain type of synchronization reference source status while performing the SL measurement (e.g. SL positioning measurement). Otherwise, UE1 does not change SYRS1 status e.g. UE1 may postpone or cancel the change of SYRS1 status. In one example, UE1 may be allowed to change from SYRS1 status to SYRS2 status provided that SYRS2 status comprises GNSS source. In another example, UE1 may be allowed to change from SYRS1 status to SYRS2 status provided that SYRS2 status is of the same type as of SYRS1 status or has the same priority as the SYRS1 status. For example, if SYRS1 status comprises SyncRefUE then UE1 can change to SYRS2 status provided that SYRS2 status comprises also a SyncRefUE. In yet another example, UE1 may be allowed to change from SYRS1 status to SYRS2 status provided both comprise a synchronization reference for a UE1 own operation or an operation not associated with a positioning operation, but not if the synchronization reference source status change comprises a change from UE1 being to not being (or vice versa) a synchronization reference for one or more other UEs or comprises any synchronization reference source status change associated with positioning operation.

In additional or alternative embodiments, UE1 may change synchronization reference source status based on a measurement type during an SL measurement (e.g. SL positioning measurement) period. In another example of the rule, whether UE1 can change SYRS1 status to another SYRS2 status while performing an SL measurement (e.g. SL positioning measurement) may depend on the type of the SL measurement (e.g. SL positioning measurement) performed by UE1. Otherwise, UE1 does not change SYRS1 e.g. UE1 may postpone or cancel the change of SYRS1. In one example, UE1 may be allowed to change from SYRS1 status to SYRS2 status provided that the SL measurement (e.g. SL positioning measurement) performed by UE1 is related to timing. Examples of such measurements are SL RSTD, SL UE Rx-Tx time difference, SL RTOA, SL TOA, RTT, etc. In another example, UE1 may be allowed to change from SYRS1 status to SYRS2 status provided that the SL measurement (e.g. SL positioning measurement) performed by UE1 is related to or involves at least measurement of UE1 transmission timing. Examples of such measurements are SL UE Rx-Tx time difference, SL timing advance, RTT, a bidirectional timing measurement, etc.

In additional or alternative embodiments, UE1 may postpone initiation of SLRS transmission during an SL measurement (e.g. SL positioning measurement) period. In another example of the rule, UE1 may postpone or delay the initiation of SLRS transmission. UE1 may initiate the SLRS transmission if the RSL (e.g. RSRP or pathloss) associated with the SYRS1 status falls below certain threshold. Examples of this threshold are syncTxThreshIC used when UE1 is in network coverage (INC), syncTxThreshOoC used when UE1 is out of network coverage (ONC). The transmission of the SLRS enables UE1 to discover a new synchronization reference source e.g. a second or a candidate synchronization reference source (associated with SYRS2 status). UE1 may postpone initiation of SLRS transmission for undefined time period or for certain time period (T21). In one example, T21 may correspond to or may be larger than the measurement period of the ongoing SL measurement (e.g. SL positioning measurement). In another example, UE1 may postpone the initiation of SLRS transmission provided that the ongoing SL measurement (e.g. SL positioning measurement) can be completed within certain time period (T22).

In additional or alternative embodiments, UE1 may cancel initiation of SLRS transmission during an SL measurement (e.g. SL positioning measurement) period: In another example of the rule, UE1 may cancel the initiation of SLRS transmission. UE1 may apply this rule even though SYRS1 status-associated RSL is below certain threshold but is still within acceptable level. UE1 may also apply this rule if SYRS1 status-associated internal clock can operate within certain accuracy (e.g. ±0.1 ppm) based on SYRS1 status-associated timing for certain time period e.g. during the SL measurement (e.g. SL positioning measurement) period.

Rules for adapting second set of procedures related to SL measurement (e.g. SL positioning measurements) are described below. These rules apply in a scenario in which UE1 changes its synchronization reference source status at least once from SYRS1 status to a second synchronization reference source status (SYRS2) while UE1 is performing an SL measurement (e.g. SL positioning measurement) during a SL measurement period.

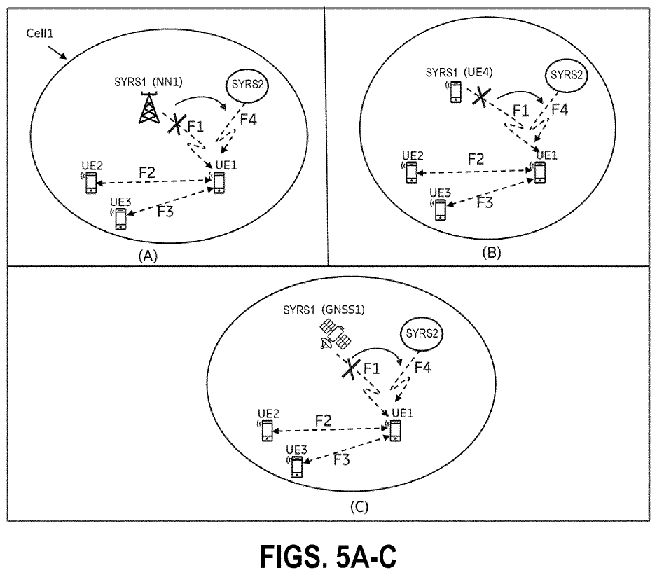

FIGS. 5A-C illustrate an example of a change of the synchronization reference source status from SYRS1 status to SYRS2 status. UE1 may receive signals associated with SYRS2 status (e.g., SYRS2 status comprise another node and the signals are received from this node) over a fourth carrier frequency (F4). In one example, F1 and F4 may be the same, while in another example, F1 and F4 may be different carriers. SYRS2 status can be of any type e.g. can comprise a second network node (NN2), a fifth UE (SyncRef UE), a second GNSS source (GNSS2), another synchronization reference for positioning, the SYRS1-to-SYRS2 status change can comprise the change from UE1 being to not being a synchronization reference for one or more other SL UEs (which can be for positioning purpose, in a specific example), etc. In some embodiments, UE1 may restart the SL measurement (e.g. SL positioning measurement) after synchronization reference source status change or transition. In one example of the rule, if UE1 changes/reselects/transitions its synchronization reference source status from SYRS1 status to a second synchronization reference source status (SYRS2) while performing an SL measurement (e.g. SL positioning measurement), then UE1 may restart the SL measurement (e.g. SL positioning measurement). In this case, UE1 may also restart the measurement period of the SL measurement (e.g. SL positioning measurement). UE1 may combine one or more samples to obtain the measurement results based on a function e.g. average, weighted average, sum, product, maximum, minimum etc. UE1 may discard the old measurement samples obtained before the changing/reselection/transition of its synchronization reference source status and may instead use measurement samples obtained after the changing/reselection/transition of its synchronization reference source status for performing the SL measurement (e.g. SL positioning measurement). In this case, the SL measurement (e.g. SL positioning measurement) period (Tme) can be longer compared to a reference or baseline measurement period (Tmr). Where Tme>Tmr. In one example, Tme=K1*Tmr. In another example, Tme=K1*Tmr+α; where K1>1 and α (α≥0) is margin (e.g. due to transition of the synchronization reference source). In one example, Tmr is the SL measurement (e.g. SL positioning measurement) period during which the synchronization reference source status does not change e.g. UE1 uses SYRS1 status during Tmr.

In some examples, this rule (restarting the SL measurement, e.g. SL positioning measurement, under the synchronization reference source status transition/change/reselection) may apply to any type of SL measurement (e.g. SL positioning measurement) performed by UE1 while the synchronization reference source status transition/change/reselection occurs.

In additional or alternative examples, this rule may apply to only timing related SL measurement (e.g. SL positioning measurement). Examples of such measurements are SL RSTD, SL UE Rx-Tx time difference, SL RTOA, SL TOA, RTT, etc.

In additional or alternative examples, this rule may apply to an SL measurement (e.g. SL positioning measurement) which involves at least measurement on signals (e.g. RS1) transmitted by UE1. Examples of such measurements are SL UE Rx-Tx time difference, SL timing advance, bidirectional measurements, RTT, etc.

In additional or alternative examples, this rule may apply to an SL measurement (e.g. SL positioning measurement) which involves at least measurement of the transmission timing of UE1 e.g. UE1 timing measured on RS1. Examples of such measurements are SL UE Rx-Tx time difference, SL timing advance, etc.

In additional or alternative examples, this rule may apply to a bi-directional SL timing positioning measurement. For example, this rule may apply if the ongoing SL positioning measurement involve both: measurement of the transmission timing of UEL and measurement of reception timing of RS (transmitted by other UE e.g. UE2 and/or UE3) at UE1. An example of such measurement is SL UE Rx-Tx time difference etc.

In additional or alternative examples, this rule may apply depending on the type of the synchronization reference source change. For example, UE1 may restart the SL measurement (e.g. SL positioning measurement) if SYRS1 and SYRS2 are of different types or have different priorities, e.g. SYRS1 is NN1 and SYRS2 is SyncRef UE. In another example, UE1 may restart the SL measurement (e.g. SL positioning measurement) if SYRS1 and/or SYRS2 are not GNSS.

In additional or alternative examples, UE1 may restart the SL measurement (e.g. SL positioning measurement) after the synchronization reference source status transition has been completed e.g. after UE1 has reselected to the new synchronization reference source status (i.e. SYRS2). In another example, UE1 may restart the SL measurement (e.g. SL positioning measurement) after UE1 has obtained timing information from or with respect to (wrt) the new synchronization reference source status (i.e. SYRS2) after the synchronization reference source reselection.

In additional or alternative examples, this rule may apply to an SL measurement (e.g. SL positioning measurement) involving two or more links in the same direction towards or from UE1 (e.g., based on two or more RSs received at UE1, based on two or more RSs transmitted by UE1, etc.) or two or more links in different directions to/from UE1 (e.g., based on at least one first RS received by UE1 and at least one second RS transmitted by UE1, wherein the first RS may or may not be transmitted by the same node as the node receiving the second RS).

In additional or alternative embodiments, UE1 may continue an SL measurement (e.g. SL positioning measurement) after synchronization reference source status change/transition. In another example of the rule, if UE1 changes/reselects/transitions its synchronization reference source status from SYRS1 status to a second synchronization reference source status (SYRS2) while performing an SL measurement (e.g. SL positioning measurement), then UE1 may continue performing the ongoing SL measurement (e.g. SL positioning measurement) after the synchronization reference source status change/reselection/transition. In this case, UE1 may combine one or more measurement samples obtained by UE1 before the synchronization reference source status transition with one or more measurement samples obtained by UE1 after the synchronization reference source status transition to obtain the measurement results based on a function (e.g. average, weighted average, sum, product, maximum, minimum etc). There can be some delay or interruption of signals due to the synchronization reference source status transition from SYRS1 to SYRS2. Therefore, in this case, the SL measurement (e.g. SL positioning measurement) period (Tme) can also be longer compared to Tmr. Where Tme>Tmr. In one example, Tme=K2*Tmr+β; where K2≥1 and β (β≥0) is a margin.

In some examples, this rule (continuing the SL measurement, e.g. SL positioning measurement, under the synchronization reference source status transition/change/reselection) may apply to any type of SL measurement (e.g. SL positioning measurement) performed by UE1 while the synchronization reference source status transition occurs.

In additional or alternative examples, this rule may apply to an SL measurement (e.g. SL positioning measurement) which involves a measurement performed by UE1 only on signals (e.g. RS2, RS2 etc) received from one or more other UEs e.g. UE2, UE3 etc. Examples of such measurements are SL RSTD, SL RSRP, SL RSRPP, SL RTOA, SL AoA etc.

In additional or alternative examples, this rule may apply to an SL measurement (e.g. SL positioning measurement) which does not involve a measurement on signals (e.g. RS1) transmitted by UE1. Examples of such measurements are SL RSTD, SL RSRP, SL RSRPP, SL RTOA, SL AoA etc.

In additional or alternative examples, this rule may apply to an SL measurement (e.g. SL positioning measurement), which does not involve a measurement of the transmission timing of UE1. Examples of such measurements are SL RSTD, SL RSRP, SL RSRPP, SL RTOA, SL AoA etc.

In additional or alternative examples, this rule may apply to an SL measurement (e.g. SL positioning measurement) which involves at least a measurement of the transmission timing of UE1. Examples of such measurements are SL UE Rx-Tx time difference, SL timing advance etc.

In additional or alternative examples, this rule may apply to a bi-directional SL timing positioning measurement. An example of such measurement is SL UE Rx-Tx time difference etc.

In additional or alternative examples, this rule may apply depending on the type of the synchronization reference source change. For example, UE1 may continue the SL measurement (e.g. SL positioning measurement) if SYRS1 status and SYRS2 status are of the same type or have the same priorities, e.g. both SYRS1 and SYRS2 are SyncRef UE. In another example, UE1 may continue the SL measurement (e.g. SL positioning measurement) if SYRS1 and/or SYRS2 are GNSS.

In additional or alternative examples, this rule may apply to an SL measurement (e.g. SL positioning measurement) involving two or more links in the same direction towards or from UE1 (e.g., based on two or more RSs received at UE1, based on two or more RSs transmitted by UE1, etc.) or two or more links in different directions to/from UE1 (e.g., based on at least one first RS received by UE1 and at least one second RS transmitted by UE1, wherein the first RS may or may not be transmitted by the same node as the node receiving the second RS).

In additional or alternative examples, this rule may apply to any SL measurement (e.g. SL positioning measurement) which is not involving two or more links in the same direction towards or from UE1 (e.g., based on two or more RSs received at UE1, based on two or more RSs transmitted by UE1, etc.) or two or more links in different directions to/from UE1 (e.g., based on at least one first RS received by UE1 and at least one second RS transmitted by UE1, wherein the first RS may or may not be transmitted by the same node as the node receiving the second RS)

In additional or alternative embodiments, UE1 may stop an SL measurement (e.g. SL positioning measurement) after synchronization reference source change/transition. In another example of the rule, if UE1 changes/reselects/transitions its synchronization reference source status from SYRS1 to a second synchronization reference source status (SYRS2) while performing an SL measurement (e.g. SL positioning measurement), then UE1 may stop performing the SL measurement (e.g. SL positioning measurement). In this case, in one example, UE1 may discard/drop the SL measurement (e.g. SL positioning measurement) results obtained before stopping the measurement e.g. does not transmit the results to another node or does not use it for positioning. In another example, UE1 may use the SL measurement (e.g. SL positioning measurement) results before stopping the measurement for one or more tasks e.g. for positioning, transmitting them to another node etc.

In some examples, this rule (stopping the SL measurement, e.g. SL positioning measurement, under the synchronization reference source transition/change/reselection) may apply to any type of SL measurement (e.g. SL positioning measurement) performed by UE1 while the synchronization reference source status transition occurs.

In additional or alternative examples, this rule may apply to only certain type of SL measurement (e.g. SL positioning measurement). For example, it may apply to the SL measurement (e.g. SL positioning measurement) used for critical operation and/or when requiring higher accuracy/precision e.g. SL RSTD, SL AoA etc.

In additional or alternative examples, this rule may apply when the SL measurement (e.g. SL positioning measurement) should not be extended (e.g. due to the synchronization reference source transition) above a certain threshold or margin.

In additional or alternative examples, this rule may apply to only timing related SL measurement (e.g. SL positioning measurement). Examples of such measurements are SL RSTD, SL UE Rx-Tx time difference, SL RTOA etc.

In additional or alternative examples, this rule may apply to an SL measurement (e.g. SL positioning measurement) which involves at least measurement on signals (e.g. RS1) transmitted by UE1. Examples of such measurements are SL UE Rx-Tx time difference, SL timing advance etc.

In additional or alternative examples, this rule may apply to an SL measurement (e.g. SL positioning measurement) which involves at least measurement of the transmission timing of UE1 e.g. UE1 timing measured on RS1. Examples of such measurements are SL UE Rx-Tx time difference, SL timing advance, etc.

In additional or alternative examples, this rule may apply to a bi-directional SL timing positioning measurement. For example, this rule may apply if the ongoing SL positioning measurement involves both: measurement of the transmission timing of UE1 and measurement of reception timing of RS (transmitted by other UE e.g. UE2 and/or UE3) at UE1. An example of such measurement is SL UE Rx-Tx time difference etc.

In additional or alternative examples, this rule may apply depending on the type of the synchronization reference source change. For example, UE1 may stop the SL measurement (e.g. SL positioning measurement) if SYRS1 status and SYRS2 status are of different types or have different priorities. In another example, UE1 may stop the SL measurement (e.g. SL positioning measurement) if SYRS1 and/or SYRS2 are not GNSS.

In additional or alternative examples, this rule may apply to an SL measurement (e.g. SL positioning measurement) involving two or more links in the same direction towards or from UE1 (e.g., based on two or more RSs received at UE1, based on two or more RSs transmitted by UE1, etc.) or two or more links in different directions to/from UE1 (e.g., based on at least one first RS received by UE1 and at least one second RS transmitted by UE1, wherein the first RS may or may not be transmitted by the same node as the node receiving the second RS)

FIGS. 5A-C illustrate an example of scenarios in which UE1 engages in SL measurements (e.g. SL positioning measurements) with UE2 and/or UE3, and changes/transitions from its current synchronization reference source (SYRS1) to a second synchronization reference source (SYRS2), which can be another UE (UE5), another GNSS (GNSS2) or another network node (NN2). FIG. 5A illustrates an example in which SYRS1 (NN1) changes to SYRS2. FIG. 5B illustrates an example in which SYRS1 (UE4) changes to SYRS2. FIG. 5C illustrates an example in which SYRS1 (GNSS1) changes to SYRS2.

Embodiments associated with a common synchronization reference source for UEs involved in SL positioning procedure are described below.

In some embodiments, all UEs involved in SL-based positioning procedure may be time synched with the same synchronization reference source. For example, the target UE (UE1) performing the SL positioning measurement and the one or more anchor UEs (e.g. UE2 and UE3) transmitting the SL PRS for positioning measurement may be time synchronized with the same node, which can be a network node (e.g. gNB in FIG. 4A) or a UE (e.g. UE4 in FIG. 4B) or a GNSS (e.g. GNSS1 in FIG. 4C). UEs may be configured to share the same synchronization reference source by a network node, such as a gNB, or by one of the UEs participating in the SL-based positioning procedure, such as UE1 (target UE) or UE2 and UE3 (anchor UEs).

In additional or alternative embodiments, a network node may configure the UE to share a gNB as a common synchronization reference source. All UEs participating in SL-based positioning procedure may use the time synchronized with the gNB during transmission and reception of SL-PRS for positioning measurements. Anchor UEs, UE2, and UE3 in FIGS. 4A-C, may use time synched with the gNB to start SL-PRS transmission. Anchor UEs, UE2 and UE3 in FIGS. 4A-C, may also use time synched with the gNB to perform RTOA measurement on an SL-PRS transmitted by the target UE. Target UE, UE1 in FIGS. 4A-C, may use time synched with the gNB to perform positioning measurements, for example RSTD or Rx-Tx time difference measurement. Target UE, UE1 in FIGS. 4A-C, may use time synched with the gNB to start transmission of the SL-PRS to be measured by anchor UEs, UE2 and UE3 in FIGS. 4A-C.

Conditions and criteria described in the embodiments above are also valid in the scenario where all UEs share a common synchronization reference source at the beginning of the SL-based positioning procedure. The conditions and criteria identified above can also be applied by anchor UEs, UE2 and UE3, in FIGS. 4A-C. In other words, anchor UEs, UE2 and UE3 in FIGS. 4A-C, can also determine a need to change synchronization reference source. When a need to change synchronization reference source is determined either by a target UE or any of the anchor UEs, the request to change synchronization reference source may be either broadcasted by the UE identifying the need to change synchronization reference source in PNC and ONC scenarios or reported to the gNB and the gNB may configure all UEs with a new common synchronization reference source or send a request to change synchronization reference source in an INC scenario.

Rules identified above remain valid to target UE, UE1, when a need to change synchronization reference source is identified by the anchor UEs and the request to change synchronization reference source is sent to target UE either via broadcast or via gNB signaling.

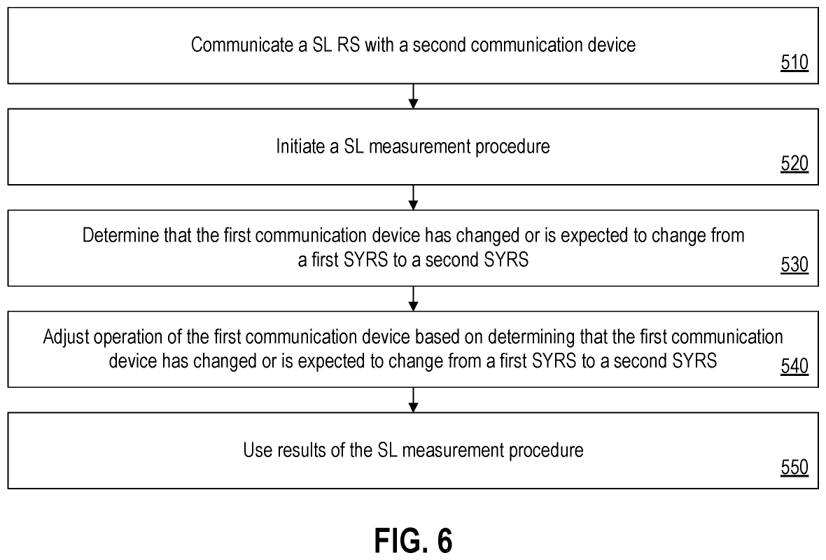

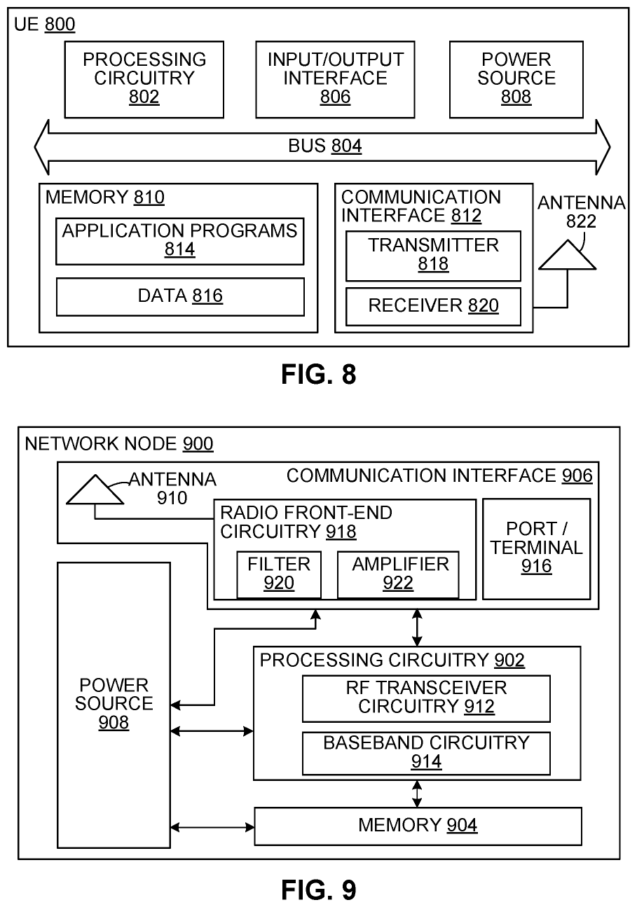

FIG. 6 illustrates a second method according to an embodiment of the disclosure. Operations of the communication device 800 (implemented using the structure of the block diagram of FIG. 8) described later will now be discussed with reference to the flow chart of FIG. 6 according to some embodiments of inventive concepts. For example, modules may be stored in memory 810 of FIG. 8, and these modules may provide instructions so that when the instructions of a module are executed by respective communication device processing circuitry 802, processing circuitry 802 performs respective operations of the flow chart.

At block 510, processing circuitry 802 communicates a sidelink, SL reference signal, RS, with the second communication device.

At block 520, processing circuitry 802 initiates the SL measurement procedure prior to initiating a synchronization reference source change procedure;

At block 530, processing circuitry 802 determines that the first communication device has changed or is expected to change from a first synchronization reference source to a second synchronization reference source prior to complete a SL measurement procedure based on the SL RS. In some embodiments, the RS is a positioning RS, PRS, and the SL measurement procedure is a SL positioning measurement procedure. In I additional or alternative embodiments, the SL measurement procedure includes performing a SL measurement over a measurement period.

In additional or alternative embodiments, determining that the first communication device has changed or is expected to change from the first synchronization reference source to the second synchronization reference source may include: measuring a received signal level, RSL, from the first synchronization reference source; and determining that the first communication device is expected to change from the first synchronization reference source to the second synchronization reference source based on a comparison of the RSL and a threshold value.

In additional or alternative embodiments, determining that the first communication device has changed or is expected to change from the first synchronization reference source to the second synchronization reference source may include receiving a message from an entity in the communications network. The message may indicate that the first communication device or the second communication device has changed or is expected to change from the first synchronization reference source to the second synchronization reference source. The entity may include at least one of: a network node; the second communication device; and a third communication device.

In additional or alternative embodiments, determining that the first communication device has changed or is expected to change from the first synchronization reference source to the second synchronization reference source may include determining that the first communication device has changed from the first synchronization reference source to the second synchronization reference source.

At block 540, processing circuitry 802 adjusts operation of the first communication device based on determining that the first communication device has changed or is expected to change from the first synchronization reference source to the second synchronization reference source. In some embodiments, adjusting operation of the first communication device may include adjusting the SL positioning measurement procedure based on determining that the first communication device has changed or is expected to change the synchronization reference source. In some examples, adjusting the SL measurement procedure may include at least one of: restarting the SL measurement procedure; continuing the SL measurement procedure; stopping the SL measurement procedure; suspending the SL measurement procedure; restarting a measurement period associated with the SL measurement procedure; and extending a measurement period associated with the SL measurement procedure.

In additional or alternative embodiments, adjusting the SL measurement procedure may include adjusting the SL measurement procedure based on a type of the SL measurement procedure. In some examples, adjusting the SL measurement procedure based on a type of the SL measurement procedure may include determining to restart the SL measurement procedure based on the SL measurement procedure including at least one of: a timing related SL positioning measurement; a timing related SL positioning measurement on at least a signal transmitted by the first communication device; a timing related SL positioning measurement on a signal transmitted by the first communication device and a signal received by the first communication device from the first communication device; and a measurement on a signal transmitted by the first communication device.

In additional or alternative examples, adjusting the SL measurement procedure based on a type of the SL measurement procedure may include determining to continue the SL measurement procedure based on the SL measurement procedure including at least one of: a measurement performed by the first communication device on a signal received from the second communication device; a measurement performed by the first communication device on signals received from the second communication device and a third communication device; and a measurement associated with an angle of arrival, AoA.

In additional or alternative examples, adjusting the SL measurement procedure may include discarding measurements obtained while using the first synchronization reference source as the synchronization reference source.

In additional or alternative embodiments, determining that the first communication device has changed or is expected to change from the first synchronization reference source to the second synchronization reference source may include determining that the first communication device has changed or is expected to change from the first synchronization reference source to the second synchronization reference source prior to initiating the SL measurement procedure based on the SL RS. Adjusting the SL measurement procedure may include delaying the SL measurement procedure until after the first communication device has changed from the first synchronization reference source to the second synchronization reference source.

In additional or alternative embodiments, adjusting the synchronization reference source procedure may include at least one of: canceling the change from the first synchronization reference source to the second synchronization reference source; delaying the change from the first synchronization reference source to the second synchronization reference source; and changing from the first synchronization reference source to a third synchronization reference source. In some examples, adjusting the synchronization reference source procedure may include adjusting the synchronization reference source procedure based on at least one of: a type of the first synchronization reference source; and a type of the second synchronization reference source.

In additional or alternative embodiments, adjusting the operation of the first communication device may include adjusting the operation of the first communication device based on the first communication device and the second communication device sharing a common synchronization reference source.

At block 550, processing circuitry 802 performs an action using the result of the SL measurement procedure. In some examples, using the result may include transmitting a message to an entity, the message including at least one of: an indication of change to the operation of the first communication device; and an indication of a result of the SL measurement procedure.

In additional or alternative examples, using the result may include performing synchronization of the first communication device based on a result of the SL measurement procedure.

In additional or alternative examples, using the result may include enhancing a range estimation based on a result of the SL measurement procedure.

Various operations from the flow chart of FIG. 6 may be optional with respect to some embodiments of communication devices and related methods.

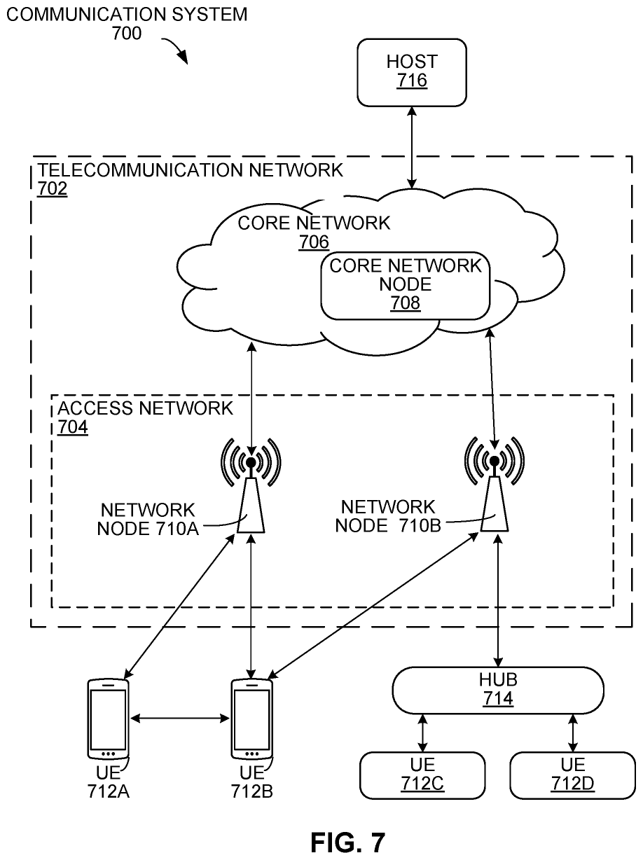

FIG. 7 shows an example of a communication system 700 in accordance with some embodiments.

In the example, the communication system 700 includes a telecommunication network 702 that includes an access network 704, such as a radio access network (RAN), and a core network 706, which includes one or more core network nodes 708. The access network 704 includes one or more access network nodes, such as network nodes 710a and 710b (one or more of which may be generally referred to as network nodes 710), or any other similar 3rd Generation Partnership Project (3GPP) access node or non-3GPP access point. Moreover, as will be appreciated by those of skill in the art, the network nodes 710 are not necessarily limited to an implementation in which a radio portion and a baseband portion are supplied and integrated by a single vendor. Thus, it will be understood that the network nodes 710 may include disaggregated implementations or portions thereof. For example, in some embodiments, the telecommunication network 702 includes one or more Open-RAN (ORAN) network nodes. An ORAN network node is a node in the telecommunication network 702 that supports an ORAN specification (e.g., a specification published by the O-RAN Alliance, or any similar organization) and may operate alone or together with other nodes to implement one or more functionalities of any node in the telecommunication network 702, including one or more network nodes 710 and/or core network nodes 708.

Examples of an ORAN network node include an open radio unit (O-RU), an open distributed unit (O-DU), an open central unit (O-CU), including an O-CU control plane (O-CU-CP) or an O-CU user plane (O-CU-UP), a RAN intelligent controller (near-real time or non-real time) hosting software or software plug-ins, such as a near-real time RAN control application (e.g., xApp) or a non-real time RAN automation application (e.g., rApp), or any combination thereof (the adjective “open” designating support of an ORAN specification). The network node may support a specification by, for example, supporting an interface defined by the ORAN specification, such as an A1, F1, W1, E1, E2, X2, Xn interface, an open fronthaul user plane interface, or an open fronthaul management plane interface. Intents and content-aware notifications described herein may be communicated from a 3GPP network node or an ORAN network node over 3GPP-defined interfaces (e.g., N2, N3) and/or ORAN Alliance-defined interfaces (e.g., A1, O1). Moreover, an ORAN network node may be a logical node in a physical node. Furthermore, an ORAN network node may be implemented in a virtualization environment (described further below) in which one or more network functions are virtualized. For example, the virtualization environment may include an O-Cloud computing platform orchestrated by a Service Management and Orchestration Framework via an O-2 interface defined by the O-RAN Alliance. The network nodes 710 facilitate direct or indirect connection of user equipment (UE), such as by connecting wireless devices 712a, 712b, 712c, and 712d (one or more of which may be generally referred to as UEs 712) to the core network 706 over one or more wireless connections. The network nodes 710 facilitate direct or indirect connection of user equipment (UE), such as by connecting UEs 712a, 712b, 712c, and 712d (one or more of which may be generally referred to as UEs 712) to the core network 706 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 700 may include any number of wired or wireless networks, network nodes, UEs, and/or any other components or systems that may facilitate or participate in the communication of data and/or signals whether via wired or wireless connections. The communication system 700 may include and/or interface with any type of communication, telecommunication, data, cellular, radio network, and/or other similar type of system.

The UEs 712 may be any of a wide variety of communication devices, including wireless devices arranged, configured, and/or operable to communicate wirelessly with the network nodes 710 and other communication devices. Similarly, the network nodes 710 are arranged, capable, configured, and/or operable to communicate directly or indirectly with the UEs 712 and/or with other network nodes or equipment in the telecommunication network 702 to enable and/or provide network access, such as wireless network access, and/or to perform other functions, such as administration in the telecommunication network 702.

In the depicted example, the core network 706 connects the network nodes 710 to one or more hosts, such as host 716. These connections may be direct or indirect via one or more intermediary networks or devices. In other examples, network nodes may be directly coupled to hosts. The core network 706 includes one more core network nodes (e.g., core network node 708) that are structured with hardware and software components. Features of these components may be substantially similar to those described with respect to the UEs, network nodes, and/or hosts, such that the descriptions thereof are generally applicable to the corresponding components of the core network node 708. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 716 may be under the ownership or control of a service provider other than an operator or provider of the access network 704 and/or the telecommunication network 702, and may be operated by the service provider or on behalf of the service provider. The host 716 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 700 of FIG. 7 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable second generation (2G), third generation (3G), fourth generation (4G), fifth generation (5G) standards, or any applicable future generation standard (e.g., sixth generation (6G)); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 702 is a cellular network that implements 3GPP standardized features. Accordingly, the telecommunications network 702 may support network slicing to provide different logical networks to different devices that are connected to the telecommunication network 702. For example, the telecommunications network 702 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 712 are configured to transmit and/or receive information without direct human interaction. For instance, a UE may be designed to transmit information to the access network 704 on a predetermined schedule, when triggered by an internal or external event, or in response to requests from the access network 704. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 714 communicates with the access network 704 to facilitate indirect communication between one or more UEs (e.g., UE 712c and/or 712d) and network nodes (e.g., network node 710b). In some examples, the hub 714 may be a controller, router, content source and analytics, or any of the other communication devices described herein regarding UEs. For example, the hub 714 may be a broadband router enabling access to the core network 706 for the UEs. As another example, the hub 714 may be a controller that sends commands or instructions to one or more actuators in the UEs. Commands or instructions may be received from the UEs, network nodes 710, or by executable code, script, process, or other instructions in the hub 714. As another example, the hub 714 may be a data collector that acts as temporary storage for UE data and, in some embodiments, may perform analysis or other processing of the data. As another example, the hub 714 may be a content source. For example, for a UE that is a virtual reality (VR) headset, display, loudspeaker or other media delivery device, the hub 714 may retrieve VR assets, video, audio, or other media or data related to sensory information via a network node, which the hub 714 then provides to the UE either directly, after performing local processing, and/or after adding additional local content. In still another example, the hub 714 acts as a proxy server or orchestrator for the UEs, in particular in if one or more of the UEs are low energy IoT devices.

The hub 714 may have a constant/persistent or intermittent connection to the network node 710b. The hub 714 may also allow for a different communication scheme and/or schedule between the hub 714 and UEs (e.g., UE 712c and/or 712d), and between the hub 714 and the core network 706. In other examples, the hub 714 is connected to the core network 706 and/or one or more UEs via a wired connection. Moreover, the hub 714 may be configured to connect to an M2M service provider over the access network 704 and/or to another UE over a direct connection. In some scenarios, UEs may establish a wireless connection with the network nodes 710 while still connected via the hub 714 via a wired or wireless connection. In some embodiments, the hub 714 may be a dedicated hub—that is, a hub whose primary function is to route communications to/from the UEs from/to the network node 710b. In other embodiments, the hub 714 may be a non-dedicated hub—that is, a device which is capable of operating to route communications between the UEs and network node 710b, but which is additionally capable of operating as a communication start and/or end point for certain data channels.

FIG. 8 shows a UE 800 in accordance with some embodiments. The UE can also be referred to herein as a communication device. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 800 includes processing circuitry 802 that is operatively coupled via a bus 804 to an input/output interface 806, a power source 808, a memory 810, a communication interface 812, and/or any other component, or any combination thereof. Certain UEs may utilize all or a subset of the components shown in FIG. 8. The level of integration between the components may vary from one UE to another UE. Further, certain UEs may contain multiple instances of a component, such as multiple processors, memories, transceivers, transmitters, receivers, etc.

The processing circuitry 802 is configured to process instructions and data and may be configured to implement any sequential state machine operative to execute instructions stored as machine-readable computer programs in the memory 810. The processing circuitry 802 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 802 may include multiple central processing units (CPUs).

The processing circuitry 802 may be configured to cause the UE 800 to perform the first method described earlier (e.g. with reference to FIG. 3), the second method described earlier (e.g. with reference to FIG. 6), or any other method described herein in relation to the UE (or in relation to the communication device, e.g. the first communication device, second communication device, and/or third communication device).

In the example, the input/output interface 806 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 800. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 808 is structured as a battery or battery pack. Other types of power sources, such as an external power source (e.g., an electricity outlet), photovoltaic device, or power cell, may be used. The power source 808 may further include power circuitry for delivering power from the power source 808 itself, and/or an external power source, to the various parts of the UE 800 via input circuitry or an interface such as an electrical power cable. Delivering power may be, for example, for charging of the power source 808. Power circuitry may perform any formatting, converting, or other modification to the power from the power source 808 to make the power suitable for the respective components of the UE 800 to which power is supplied.

The memory 810 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 810 includes one or more application programs 814, such as an operating system, web browser application, a widget, gadget engine, or other application, and corresponding data 816. The memory 810 may store, for use by the UE 800, any of a variety of various operating systems or combinations of operating systems.

The memory 810 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 810 may allow the UE 800 to access instructions, application programs and the like, stored on transitory or non-transitory memory media, to off-load data, or to upload data. An article of manufacture, such as one utilizing a communication system may be tangibly embodied as or in the memory 810, which may be or comprise a device-readable storage medium.

The processing circuitry 802 may be configured to communicate with an access network or other network using the communication interface 812. The communication interface 812 may comprise one or more communication subsystems and may include or be communicatively coupled to an antenna 822. The communication interface 812 may include one or more transceivers used to communicate, such as by communicating with one or more remote transceivers of another device capable of wireless communication (e.g., another UE or a network node in an access network). Each transceiver may include a transmitter 818 and/or a receiver 820 appropriate to provide network communications (e.g., optical, electrical, frequency allocations, and so forth). Moreover, the transmitter 818 and receiver 820 may be coupled to one or more antennas (e.g., antenna 822) and may share circuit components, software or firmware, or alternatively be implemented separately.

In the illustrated embodiment, communication functions of the communication interface 812 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 812, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 800 shown in FIG. 8.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 9 shows a network node 900 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs), NR NodeBs (gNBs)), O-RAN nodes, or components of an O-RAN node (e.g., intelligent controller, O-RU, O-DU, O-CU).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 900 includes a processing circuitry 902, a memory 904, a communication interface 906, and a power source 908. The network node 900 may be composed of multiple physically separate components (e.g., a NodeB component and a RNC component, or a BTS component and a BSC component, etc.), which may each have their own respective components. In certain scenarios in which the network node 900 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 900 may be configured to support multiple radio access technologies (RATs). In such embodiments, some components may be duplicated (e.g., separate memory 904 for different RATs) and some components may be reused (e.g., a same antenna 910 may be shared by different RATs). The network node 900 may also include multiple sets of the various illustrated components for different wireless technologies integrated into network node 900, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 900.

The processing circuitry 902 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 900 components, such as the memory 904, to provide network node 900 functionality.

In some embodiments, the processing circuitry 902 includes a system on a chip (SOC). In some embodiments, the processing circuitry 902 includes one or more of radio frequency (RF) transceiver circuitry 912 and baseband processing circuitry 914. In some embodiments, the radio frequency (RF) transceiver circuitry 912 and the baseband processing circuitry 914 may be on separate chips (or sets of chips), boards, or units, such as radio units and digital units. In alternative embodiments, part or all of RF transceiver circuitry 912 and baseband processing circuitry 914 may be on the same chip or set of chips, boards, or units.

The memory 904 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 902. The memory 904 may store any suitable instructions, data, or information, including a computer program, software, an application including one or more of logic, rules, code, tables, and/or other instructions capable of being executed by the processing circuitry 902 and utilized by the network node 900. The memory 904 may be used to store any calculations made by the processing circuitry 902 and/or any data received via the communication interface 906. In some embodiments, the processing circuitry 902 and memory 904 is integrated.

The communication interface 906 is used in wired or wireless communication of signaling and/or data between a network node, access network, and/or UE. As illustrated, the communication interface 906 comprises port(s)/terminal(s) 916 to send and receive data, for example to and from a network over a wired connection. The communication interface 906 also includes radio front-end circuitry 918 that may be coupled to, or in certain embodiments a part of, the antenna 910. Radio front-end circuitry 918 comprises filters 920 and amplifiers 922. The radio front-end circuitry 918 may be connected to an antenna 910 and processing circuitry 902. The radio front-end circuitry may be configured to condition signals communicated between antenna 910 and processing circuitry 902. The radio front-end circuitry 918 may receive digital data that is to be sent out to other network nodes or UEs via a wireless connection. The radio front-end circuitry 918 may convert the digital data into a radio signal having the appropriate channel and bandwidth parameters using a combination of filters 920 and/or amplifiers 922. The radio signal may then be transmitted via the antenna 910. Similarly, when receiving data, the antenna 910 may collect radio signals which are then converted into digital data by the radio front-end circuitry 918. The digital data may be passed to the processing circuitry 902. In other embodiments, the communication interface may comprise different components and/or different combinations of components.

In certain alternative embodiments, the network node 900 does not include separate radio front-end circuitry 918, instead, the processing circuitry 902 includes radio front-end circuitry and is connected to the antenna 910. Similarly, in some embodiments, all or some of the RF transceiver circuitry 912 is part of the communication interface 906. In still other embodiments, the communication interface 906 includes one or more ports or terminals 916, the radio front-end circuitry 918, and the RF transceiver circuitry 912, as part of a radio unit (not shown), and the communication interface 906 communicates with the baseband processing circuitry 914, which is part of a digital unit (not shown).

The antenna 910 may include one or more antennas, or antenna arrays, configured to send and/or receive wireless signals. The antenna 910 may be coupled to the radio front-end circuitry 918 and may be any type of antenna capable of transmitting and receiving data and/or signals wirelessly. In certain embodiments, the antenna 910 is separate from the network node 900 and connectable to the network node 900 through an interface or port.

The antenna 910, communication interface 906, and/or the processing circuitry 902 may be configured to perform any receiving operations and/or certain obtaining operations described herein as being performed by the network node. Any information, data and/or signals may be received from a UE, another network node and/or any other network equipment. Similarly, the antenna 910, the communication interface 906, and/or the processing circuitry 902 may be configured to perform any transmitting operations described herein as being performed by the network node. Any information, data and/or signals may be transmitted to a UE, another network node and/or any other network equipment.

The power source 908 provides power to the various components of network node 900 in a form suitable for the respective components (e.g., at a voltage and current level needed for each respective component). The power source 908 may further comprise, or be coupled to, power management circuitry to supply the components of the network node 900 with power for performing the functionality described herein. For example, the network node 900 may be connectable to an external power source (e.g., the power grid, an electricity outlet) via an input circuitry or interface such as an electrical cable, whereby the external power source supplies power to power circuitry of the power source 908. As a further example, the power source 908 may comprise a source of power in the form of a battery or battery pack which is connected to, or integrated in, power circuitry. The battery may provide backup power should the external power source fail.

Embodiments of the network node 900 may include additional components beyond those shown in FIG. 9 for providing certain aspects of the network node's functionality, including any of the functionality described herein and/or any functionality necessary to support the subject matter described herein. For example, the network node 900 may include user interface equipment to allow input of information into the network node 900 and to allow output of information from the network node 900. This may allow a user to perform diagnostic, maintenance, repair, and other administrative functions for the network node 900.

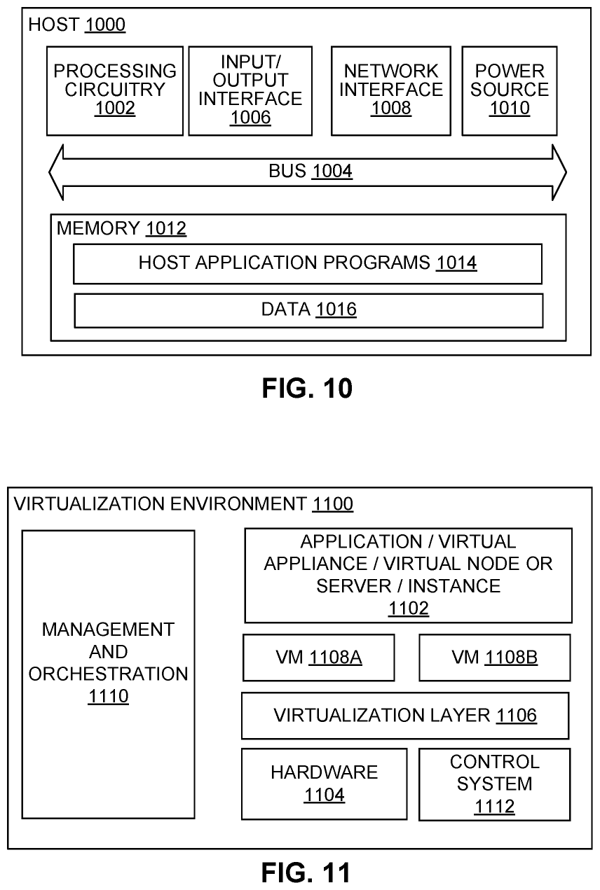

FIG. 10 is a block diagram of a host 1000, which may be an embodiment of the host 716 of FIG. 7, in accordance with various aspects described herein. As used herein, the host 1000 may be or comprise various combinations hardware and/or software, including a standalone server, a blade server, a cloud-implemented server, a distributed server, a virtual machine, container, or processing resources in a server farm. The host 1000 may provide one or more services to one or more UEs.

The host 1000 includes processing circuitry 1002 that is operatively coupled via a bus 1004 to an input/output interface 1006, a network interface 1008, a power source 1010, and a memory 1012. Other components may be included in other embodiments. Features of these components may be substantially similar to those described with respect to the devices of previous figures, such as FIGS. 8 and 9, such that the descriptions thereof are generally applicable to the corresponding components of host 1000.

The memory 1012 may include one or more computer programs including one or more host application programs 1014 and data 1016, which may include user data, e.g., data generated by a UE for the host 1000 or data generated by the host 1000 for a UE. Embodiments of the host 1000 may utilize only a subset or all of the components shown. The host application programs 1014 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1014 may also provide for user authentication and licensing checks and may periodically report health, routes, and content availability to a central node, such as a device in or on the edge of a core network. Accordingly, the host 1000 may select and/or indicate a different host for over-the-top services for a UE. The host application programs 1014 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 11 is a block diagram illustrating a virtualization environment 1100 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1100 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized. In some embodiments, the virtualization environment 1100 includes components defined by the O-RAN Alliance, such as an O-Cloud environment orchestrated by a Service Management and Orchestration Framework via an O-2 interface.

Applications 1102 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1104 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1106 (also referred to as hypervisors or virtual machine monitors (VMMs)), provide VMs 1108a and 1108b (one or more of which may be generally referred to as VMs 1108), and/or perform any of the functions, features and/or benefits described in relation with some embodiments described herein. The virtualization layer 1106 may present a virtual operating platform that appears like networking hardware to the VMs 1108.

The VMs 1108 comprise virtual processing, virtual memory, virtual networking or interface and virtual storage, and may be run by a corresponding virtualization layer 1106. Different embodiments of the instance of a virtual appliance 1102 may be implemented on one or more of VMs 1108, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1108 may be a software implementation of a physical machine that runs programs as if they were executing on a physical, non-virtualized machine. Each of the VMs 1108, and that part of hardware 1104 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1108 on top of the hardware 1104 and corresponds to the application 1102.

Hardware 1104 may be implemented in a standalone network node with generic or specific components. Hardware 1104 may implement some functions via virtualization. Alternatively, hardware 1104 may be part of a larger cluster of hardware (e.g. such as in a data center or CPE) where many hardware nodes work together and are managed via management and orchestration 1110, which, among others, oversees lifecycle management of applications 1102. In some embodiments, hardware 1104 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1112 which may alternatively be used for communication between hardware nodes and radio units.

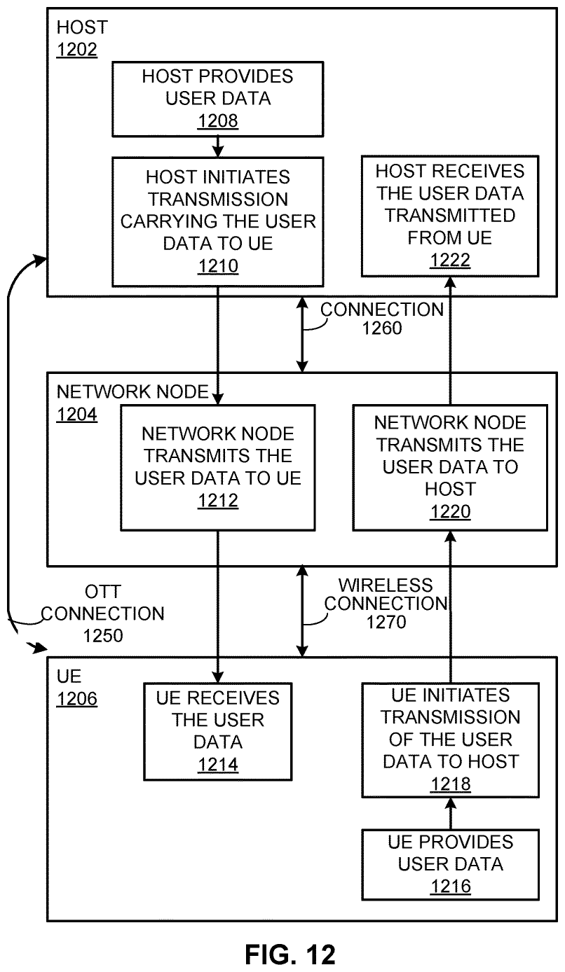

FIG. 12 shows a communication diagram of a host 1202 communicating via a network node 1204 with a UE 1206 over a partially wireless connection in accordance with some embodiments. Example implementations, in accordance with various embodiments, of the UE (such as a UE 712a of FIG. 7 and/or UE 800 of FIG. 8), network node (such as network node 710a of FIG. 7 and/or network node QQ300 of FIG. 9), and host (such as host 716 of FIG. 7 and/or host 1000 of FIG. 10) discussed in the preceding paragraphs will now be described with reference to FIG. 12.

Like host 1000, embodiments of host 1202 include hardware, such as a communication interface, processing circuitry, and memory. The host 1202 also includes software, which is stored in or accessible by the host 1202 and executable by the processing circuitry. The software includes a host application that may be operable to provide a service to a remote user, such as the UE 1206 connecting via an over-the-top (OTT) connection 1250 extending between the UE 1206 and host 1202. In providing the service to the remote user, a host application may provide user data which is transmitted using the OTT connection 1250.

The network node 1204 includes hardware enabling it to communicate with the host 1202 and UE 1206. The connection 1260 may be direct or pass through a core network (like core network 706 of FIG. 7) and/or one or more other intermediate networks, such as one or more public, private, or hosted networks. For example, an intermediate network may be a backbone network or the Internet.

The UE 1206 includes hardware and software, which is stored in or accessible by UE 1206 and executable by the UE's processing circuitry. The software includes a client application, such as a web browser or operator-specific “app” that may be operable to provide a service to a human or non-human user via UE 1206 with the support of the host 1202. In the host 1202, an executing host application may communicate with the executing client application via the OTT connection 1250 terminating at the UE 1206 and host 1202. In providing the service to the user, the UE's client application may receive request data from the host's host application and provide user data in response to the request data. The OTT connection 1250 may transfer both the request data and the user data. The UE's client application may interact with the user to generate the user data that it provides to the host application through the OTT connection 1250.

The OTT connection 1250 may extend via a connection 1260 between the host 1202 and the network node 1204 and via a wireless connection 1270 between the network node 1204 and the UE 1206 to provide the connection between the host 1202 and the UE 1206. The connection 1260 and wireless connection 1270, over which the OTT connection 1250 may be provided, have been drawn abstractly to illustrate the communication between the host 1202 and the UE 1206 via the network node 1204, without explicit reference to any intermediary devices and the precise routing of messages via these devices.

As an example of transmitting data via the OTT connection 1250, in step 1208, the host 1202 provides user data, which may be performed by executing a host application. In some embodiments, the user data is associated with a particular human user interacting with the UE 1206. In other embodiments, the user data is associated with a UE 1206 that shares data with the host 1202 without explicit human interaction. In step 1210, the host 1202 initiates a transmission carrying the user data towards the UE 1206. The host 1202 may initiate the transmission responsive to a request transmitted by the UE 1206. The request may be caused by human interaction with the UE 1206 or by operation of the client application executing on the UE 1206. The transmission may pass via the network node 1204, in accordance with the teachings of the embodiments described throughout this disclosure. Accordingly, in step 1212, the network node 1204 transmits to the UE 1206 the user data that was carried in the transmission that the host 1202 initiated, in accordance with the teachings of the embodiments described throughout this disclosure. In step 1214, the UE 1206 receives the user data carried in the transmission, which may be performed by a client application executed on the UE 1206 associated with the host application executed by the host 1202.

In some examples, the UE 1206 executes a client application which provides user data to the host 1202. The user data may be provided in reaction or response to the data received from the host 1202. Accordingly, in step 1216, the UE 1206 may provide user data, which may be performed by executing the client application. In providing the user data, the client application may further consider user input received from the user via an input/output interface of the UE 1206. Regardless of the specific manner in which the user data was provided, the UE 1206 initiates, in step 1218, transmission of the user data towards the host 1202 via the network node 1204. In step 1220, in accordance with the teachings of the embodiments described throughout this disclosure, the network node 1204 receives user data from the UE 1206 and initiates transmission of the received user data towards the host 1202. In step 1222, the host 1202 receives the user data carried in the transmission initiated by the UE 1206.

One or more of the various embodiments improve the performance of OTT services provided to the UE 1206 using the OTT connection 1250, in which the wireless connection 1270 forms the last segment. More precisely, the teachings of these embodiments may enable consistent and well defined UE behavior in terms of the SL measurement (e.g. SL positioning measurement) procedure. In some embodiments, the UE is able to perform SL measurements (e.g. SL positioning measurements) even when the synchronization reference source changes. In additional or alternative embodiments, the SL measurement (e.g. SL positioning measurement) performance is enhanced while the synchronization reference source changes during the SL measurement (e.g. SL positioning measurement) period. This in turn enhances the UE positioning accuracy as it relies on the SL measurement (e.g. SL positioning measurement).

In an example scenario, factory status information may be collected and analyzed by the host 1202. As another example, the host 1202 may process audio and video data which may have been retrieved from a UE for use in creating maps. As another example, the host 1202 may collect and analyze real-time data to assist in controlling vehicle congestion (e.g., controlling traffic lights). As another example, the host 1202 may store surveillance video uploaded by a UE. As another example, the host 1202 may store or control access to media content such as video, audio, VR or AR which it can broadcast, multicast or unicast to UEs. As other examples, the host 1202 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1250 between the host 1202 and UE 1206, in response to variations in the measurement results. The measurement procedure and/or the network functionality for reconfiguring the OTT connection may be implemented in software and hardware of the host 1202 and/or UE 1206. In some embodiments, sensors (not shown) may be deployed in or in association with other devices through which the OTT connection 1250 passes; the sensors may participate in the measurement procedure by supplying values of the monitored quantities exemplified above, or supplying values of other physical quantities from which software may compute or estimate the monitored quantities. The reconfiguring of the OTT connection 1250 may include message format, retransmission settings, preferred routing etc.; the reconfiguring need not directly alter the operation of the network node 1204. Such procedures and functionalities may be known and practiced in the art. In certain embodiments, measurements may involve proprietary UE signaling that facilitates measurements of throughput, propagation times, latency and the like, by the host 1202. The measurements may be implemented in that software causes messages to be transmitted, in particular empty or ‘dummy’ messages, using the OTT connection 1250 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

Other embodiments of the present disclosure are defined in the following numbered statements:

Statement 1. A method of operating a first communication device in a communications network that includes a second communication device, the method comprising:
communicating (510) a sidelink, SL, reference signal, RS, with the second communication device;
determining (530) that the first communication device has changed or is expected to change from a first synchronization reference source, SRS, to a second SRS prior to completing a SL measurement procedure based on the SL RS; and
adjusting (540) operation of the first communication device based on determining that the first communication device has changed or is expected to change from the first SRS to the second SRS.

Statement 2. The method of Statement 1, wherein the RS is a positioning RS, PRS, and
wherein the SL measurement procedure is a SL positioning measurement procedure.

Statement 3. The method of any of Statements 1-2, wherein the SL measurement procedure comprising performing a SL measurement over a measurement period.

Statement 4. The method of any of Statements 1-3, wherein adjusting operation of the first communication device comprises adjusting the SL positioning measurement procedure based on determining that the first communication device has changed or is expected to change the SRS.

Statement 5. The method of Statements 4, wherein adjusting the SL measurement procedure comprises at least one of:
restarting the SL measurement procedure;
continuing the SL measurement procedure;
stopping the SL measurement procedure;
suspending the SL measurement procedure;
restarting a measurement period associated with the SL measurement procedure; and
extending a measurement period associated with the SL measurement procedure.

Statement 6. The method of any of Statements 4-5, wherein adjusting the SL measurement procedure comprises adjusting the SL measurement procedure based on a type of the SL measurement procedure.

Statement 7. The method of Statement 6, wherein adjusting the SL measurement procedure based on a type of the SL measurement procedure comprises determining to restart the SL measurement procedure based on the SL measurement procedure including at least one of:
a timing related SL positioning measurement;
a timing related SL positioning measurement on at least a signal transmitted by the first communication device;
a timing related SL positioning measurement on a signal transmitted by the first communication device and a signal received by the first communication device from the first communication device; and
a measurement on a signal transmitted by the first communication device.

Statement 8. The method of Statement 6, wherein adjusting the SL measurement procedure based on a type of the SL measurement procedure comprises determining to continue the SL measurement procedure based on the SL measurement procedure including at least one of:
a measurement performed by the first communication device on a signal received from the second communication device;
a measurement performed by the first communication device on signals received from the second communication device and a third communication device; and
a measurement associated with an angle of arrival, AoA.

Statement 9. The method of any of Statements 4-8, wherein adjusting the SL measurement procedure comprises discarding measurements obtained while using the first SRS as the synchronization reference source.

Statement 10. The method of any of Statements 4-9, wherein determining that the first communication device has changed or is expected to change from the first SRS to the second SRS comprises determining that the first communication device has changed or is expected to change from the first SRS to the second SRS prior to initiating the SL measurement procedure based on the SL RS,
wherein adjusting the SL measurement procedure comprises delaying the SL measurement procedure until after the first communication device has changed from the first SRS to the second SRS.

Statement 11. The method of any of Statements 1-10, the method further comprising:
initiating (520) the SL measurement procedure prior to initiating a SRS change procedure,
wherein adjusting operation of the first communication device comprises adjusting a SRS procedure based on initiating the SL measurement procedure prior to initiating a SRS change procedure.

Statement 12. The method of Statement 11, wherein adjusting the SRS procedure comprises at least one of:
canceling the change from the first SRS to the second SRS;
delaying the change from the first SRS to the second SRS; and
changing from the first SRS to a third SRS.

Statement 13. The method of any of Statements 12-13, wherein adjusting the SRS procedure comprises adjusting the SRS procedure based on at least one of:
a type of the first SRS; and
a type of the second SRS.

Statement 14. The method of any of Statements 1-13, wherein adjusting the operation of the first communication device comprises adjusting the operation of the first communication device based on the first communication device and the second communication device sharing a common SRS.

Statement 15. The method of any of Statements 1-14, wherein determining that the first communication device has changed or is expected to change from the first SRS to the second SRS comprises:
measuring a received signal level, RSL, from the first SRS; and
determining that the first communication device is expected to change from the first SRS to the second SRS based on a comparison of the RSL and a threshold value.

Statement 16. The method of any of Statements 1-15, wherein determining that the first communication device has changed or is expected to change from the first SRS to the second SRS comprises receiving a message from an entity in the communications network, the message indicating that the first communication device or the second communication device has changed or is expected to change from the first SRS to the second SRS, and
wherein the entity comprises at least one of:
   a network node;
   the second communication device; and
   a third communication device.

Statement 17. The method of any of Statements 1-16, wherein determining that the first communication device has changed or is expected to change from the first SRS to the second SRS comprises determining that the first communication device has changed from the first SRS to the second SRS.

Statement 18. The method of any of Statements 1-17, further comprising:
transmitting (550) a message to an entity, the message including at least one of:
   an indication of change to the operation of the first communication device; and
   an indication of a result of the SL measurement procedure.

Statement 19. The method of any of Statements 1-18, further comprising:
performing (550) synchronization of the first communication device based on a result of the SL measurement procedure.

Statement 20. The method of any of Statements 1-19, further comprising:
enhancing (550) a range estimation based on a result of the SL measurement procedure.

Statement 21. A communication device (800), the communication device comprising:
processing circuitry (802); and
memory (810) coupled to the processing circuitry and having instructions stored therein that are executable by the processing circuitry to cause the communication device to perform operations comprising any of the operations of Statements 1-20.

Statement 22. A computer program comprising program code to be executed by processing circuitry (802) of a communication device (800), whereby execution of the program code causes the communication device to perform operations comprising any operations of Statements 1-20.

Statement 23. A computer program product comprising a non-transitory storage medium (810) including program code to be executed by processing circuitry (802) of a communication device (900), whereby execution of the program code causes the communication device to perform operations comprising any operations of Statements 1-20.

Statement 24. A non-transitory computer-readable medium having instructions stored therein that are executable by processing circuitry (802) of a communication device (800) to cause the communication device to perform operations comprising any of the operations of Statements 1-20.

Statement 25. A host configured to operate in a communication system to provide an over-the-top (OTT) service, the host comprising:
processing circuitry configured to provide user data; and
a network interface configured to initiate transmission of the user data to a cellular network for transmission to a user equipment (UE), wherein the UE comprises a communication interface and processing circuitry, the communication interface and processing circuitry of the UE being configured to perform the following operations to receive the user data from the host:
   communicating (510) a sidelink, SL, reference signal, RS, with the second communication device;
   determining (530) that the first communication device has changed or is expected to change from a first synchronization reference source, SRS, to a second SRS prior to completing a SL measurement procedure based on the SL RS;
   adjusting (540) operation of the first communication device based on determining that the first communication device has changed or is expected to change from the first SRS to the second SRS.

Statement 26. The host of the previous Statement, wherein the cellular network further includes a network node configured to communicate with the UE to transmit the user data to the UE from the host.

Statement 27. The host of the previous 2 Statements, wherein:
the processing circuitry of the host is configured to execute a host application, thereby providing the user data; and
the host application is configured to interact with a client application executing on the UE, the client application being associated with the host application.

Statement 28. A method implemented by a host operating in a communication system that further includes a network node and a user equipment (UE), the method comprising:
providing user data for the UE; and
initiating a transmission carrying the user data to the UE via a cellular network comprising the network node, wherein the UE performs the following operations to receive the user data from the host:
   communicating (510) a sidelink, SL, reference signal, RS, with the second communication device;
   determining (530) that the first communication device has changed or is expected to change from a first synchronization reference source, SRS, to a second SRS prior to completing a SL measurement procedure based on the SL RS;
   adjusting (540) operation of the first communication device based on determining that the first communication device has changed or is expected to change from the first SRS to the second SRS.

Statement 29. The method of the previous Statement, further comprising:
at the host, executing a host application associated with a client application executing on the UE to receive the user data from the UE.

Statement 30. The method of the previous Statement, further comprising:
at the host, transmitting input data to the client application executing on the UE, the input data being provided by executing the host application,
wherein the user data is provided by the client application in response to the input data from the host application.

Statement 31. A host configured to operate in a communication system to provide an over-the-top (OTT) service, the host comprising:
processing circuitry configured to utilize user data; and
a network interface configured to receipt of transmission of the user data to a cellular network for transmission to a user equipment (UE),
wherein the UE comprises a communication interface and processing circuitry, the communication interface and processing circuitry of the UE being configured to perform the following operations to transmit the user data to the host:
   communicating (510) a sidelink, SL, reference signal, RS, with the second communication device;
   determining (530) that the first communication device has changed or is expected to change from a first synchronization reference source, SRS, to a second SRS prior to completing a SL measurement procedure based on the SL RS;
   adjusting (540) operation of the first communication device based on determining that the first communication device has changed or is expected to change from the first SRS to the second SRS.

Statement 32. The host of the previous Statement, wherein the cellular network further includes a network node configured to communicate with the UE to transmit the user data from the UE to the host.

Statement 33. The host of the previous 2 Statements, wherein:
the processing circuitry of the host is configured to execute a host application, thereby providing the user data; and
the host application is configured to interact with a client application executing on the UE, the client application being associated with the host application.

Statement 34. A method implemented by a host configured to operate in a communication system that further includes a network node and a user equipment (UE), the method comprising:
at the host, receiving user data transmitted to the host via the network node by the UE, wherein the UE performs the following operations to transmit the user data to the host:
   communicating (510) a sidelink, SL, reference signal, RS, with the second communication device;
   determining (530) that the first communication device has changed or is expected to change from a first synchronization reference source, SRS, to a second SRS prior to completing a SL measurement procedure based on the SL RS;
   adjusting (540) operation of the first communication device based on determining that the first communication device has changed or is expected to change from the first SRS to the second SRS.

Statement 35. The method of the previous Statement, further comprising:
at the host, executing a host application associated with a client application executing on the UE to receive the user data from the UE.

Statement 36. The method of the previous Statements, further comprising:
at the host, transmitting input data to the client application executing on the UE, the input data being provided by executing the host application,
wherein the user data is provided by the client application in response to the input data from the host application.

It should be noted that the above-mentioned embodiments illustrate rather than limit the idea, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

### APPENDIX A

### 1 Introduction

The work items for SL in RAN2 include
Specify signalling and associated UE behavior for support of unicast, groupcast (not including many to one) and broadcast of SL PRS transmissions [RAN1, RAN2].
Specify reporting signalling and procedures to facilitate support of SL positioning in all coverage scenarios and for PC5-only and joint PC5-Uu scenarios [RAN2, RAN3]:
   Specify the protocol and procedures for SL positioning between UEs (Protocol for Sidelink positioning procedures (SLPP)).
   Specify the protocol and procedures for SL positioning between UEs and LMF.

In this paper, we discuss the potential signalling procedures for LPP extension to support SL ranging/positioning.
1) Hybrid Positioning with LPP Extension 2) SLPP protocol Stack Discussion 3) Discovery Procedure 4) Overhearing

### 2 Discussion

2.1 Hybrid Positioning with LPP Extension

There are different use cases which require LMF to perform hybrid positioning such as request from external client to be able to provide the range between two UEs or improve the UE positioning accuracy with assistance from another UE such as reference UE/PRU. For ranging determination, to improve the reliability and accuracy of range estimation; LMF can perform hybrid positioning such as obtain the absolute UE location (using Uu (UE and NW) measurements) and also range estimation between UEs SL measurements.

For SL ranging/positioning, signalling procedures including capability exchange, reference UE selection, assistance data transfer, ranging/sidelink positioning measurement, report and calculation are needed. For IC scenario, LMF can collect and provide the above IEs to calculate the requested ranging/positioning results as in LPP. Such signalling procedures are similar to the LPP procedures, it is natural to extend LPP with signalling procedures for SL ranging/positioning.

LPP session should be extended such that multiple UEs can join the positioning session with LMF and allow LMF to perform hybrid Positioning. LPP with signalling procedures for SL ranging/positioning which is used at Uu interface between LMF and UE should also support SL UE to UE operations.

### 2.1.1 Extended LPP Session for Ranging/SL Positioning

There can be below two Options on how LPP session can be extended to accommodate SL operations.
Option1: A common LPP session to have multiple target devices. Transaction ID range to different target devices are set to different range in order not to collide.
Option2: Multiple LPP sessions each with one individual device are used to support a single ranging/SL positioning request. The association between SL session and Uu session has to be maintained by LMF.

Option 2 has less impact to the legacy LPP.

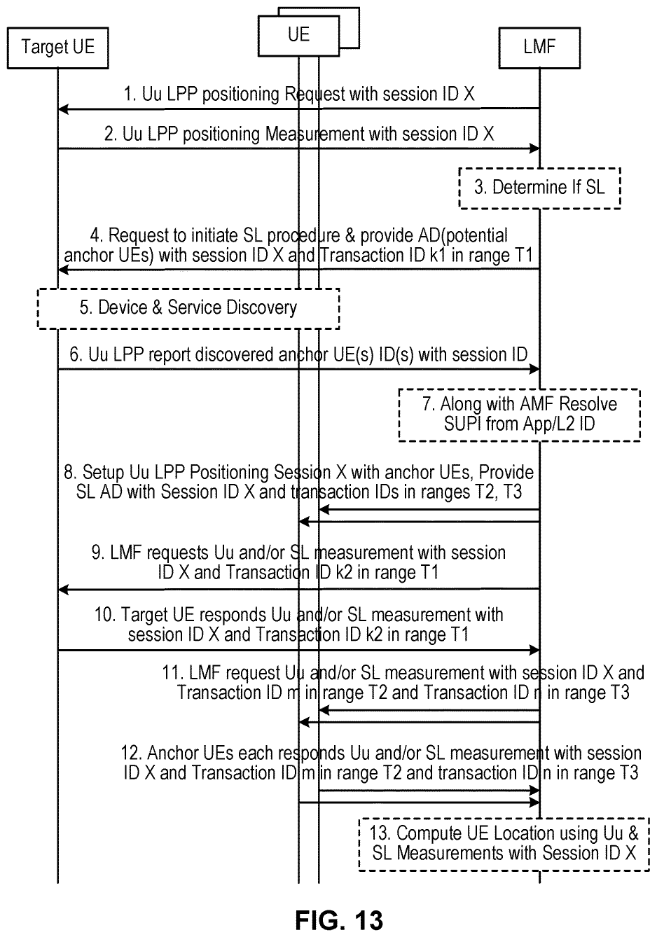

FIG. 13 illustrates an example extended LPP session procedure with Option 1.

The steps in FIG. 13 are as follows:
Step 1. A Uu LPP positioning request with session ID X is either sent from LMF to target UE.
Step 2. Target UE reports Uu measurement to LMF with session ID X.
Step 3. Based on the Uu measurement from target UE in step 2, LMF decide if SL measurement is needed. If not needed, LMF calculates target UE's position. If needed, continue to below steps.
Step 4. LMF sends request to target UE to initiate SL procedure & provide AD (potential anchor UEs) with session ID X and Transaction ID k1 in range T1
Step 5. Target UE discover anchor UEs.
Step 6. Target UE report discovered anchor UE(s) ID(s) to LMF using Uu LPP with session ID X and Transaction ID k1 in range T1.
Step 7. Along with AMF, LMF resolve SUPI of the anchor UEs from their App/L2 ID
Step 8. LMF sets up Uu LPP Positioning Sessions and provide SL AD with anchor UEs with Session ID X and Transaction IDs in ranges T2, T3 respectively.
Step 9. LMF requests the target UE to perform Uu and/or SL measurement with session ID X and Transaction ID k2 in range T1.
Step 10. Target UE responds to LMF with Uu and/or SL measurement with session ID X and Transaction ID k2 in range T1
Step 11. LMF requests the anchor UEs to perform Uu and/or SL measurement with session ID X and Transaction ID m in range T2 and Transaction ID n in range T3
Step 12. Anchor UEs responds to LMF with Uu and/or SL measurement with session ID X and Transaction ID m in range T2 and Transaction ID n in range T3
Step 13. LMF computes target UE Location using Uu & SL Measurements with Session ID X

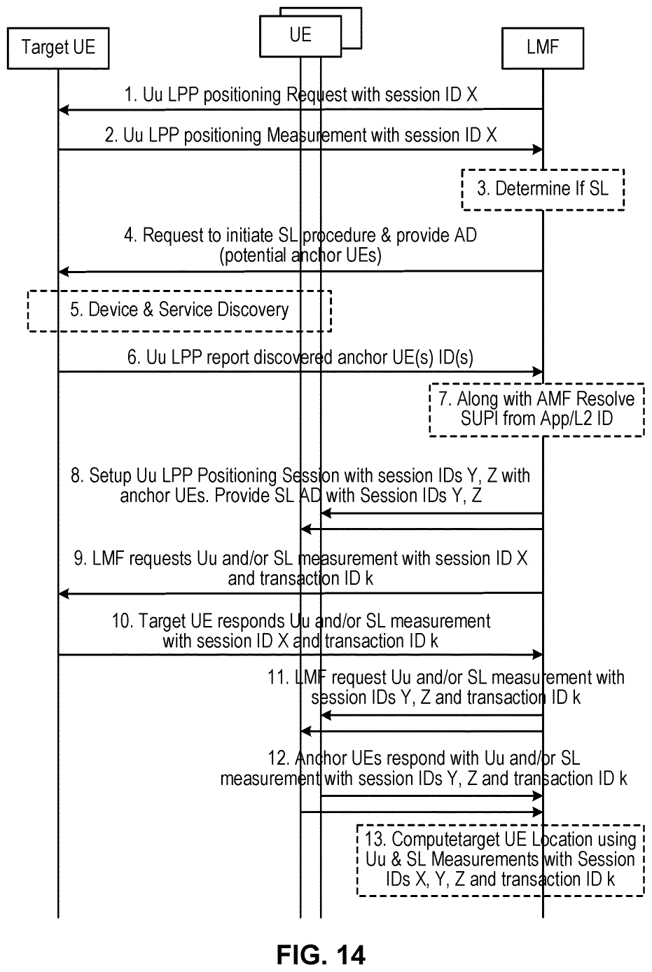

FIG. 14 illustrates an example extended LPP session procedure with Option 2.

The steps in FIG. 14 are as follows:
Step 1. A Uu LPP positioning request with session ID X is either sent from LMF to target UE.
Step 2. Target UE reports Uu measurement to LMF with session ID X.
Step 3. Based on the Uu measurement from target UE in step 2, LMF decide if SL measurement is needed. If not needed, LMF calculates target UE's position. If needed, continue to below steps.
Step 4. LMF sends request to target UE to initiate SL procedure & provide AD (potential anchor UEs)
Step 5. Target UE discover anchor UEs.
Step 6. Target UE report discovered anchor UE(s) ID(s) to LMF using Uu LPP.
Step 7. Along with AMF, LMF resolve SUPI of the anchor UEs from their App/L2 ID
Step 8. LMF sets up Uu LPP Positioning Session with session IDs Y, Z with anchor UEs, Provide SL AD with Session IDs Y, Z.
Step 9. LMF requests the target UE to perform Uu and/or SL measurement with session ID X and transaction ID k.
Step 10. Target UE responds to LMF with Uu and/or SL measurement with session ID X and transaction ID k
Step 11. LMF requests the anchor UEs to perform Uu and/or SL measurement with session IDs Y, Z and transaction ID k
Step 12. Anchor UEs responds to LMF with Uu and/or SL measurement with session IDs Y, Z and transaction ID k
Step 13. LMF computes target UE Location using Uu & SL Measurements with Session IDs X, Y, Z and transaction ID k

In above examples, apart from Uu operation, there has to be sidelink operations between UEs and also one of the UEs can be a reference UE/PRU. We see the steps needed are:
LMF should be able to establish LPP session with UEs and configure SLPP configuration between UEs (considering they are in same cell or area); Or
A target UE should be able to convey to LMF that it has discovered a PRU,
The LMF should be able to resolve SL L2/Application ID of PRU to SUPI and establish LPP session for Uu measurements
The LMF should be able to setup Uu positioning with target UE and PRU,
The LMF should be able to provide SL AD or request to gNB to allocate resource and provide configuration for SL-PRS configuration
The LMF should be able to obtain both SL measurements and Uu measurements from multiple UEs.

LPP session between UE and NW is extended to support UE to UE SL Operations and to allow LMF to execute hybrid Positioning procedures by obtaining Uu and SL measurements

The target UE shall discover a reference UE/PRU and report to LMF and LMF setups LPP positioning session with the reference UE/PRU and SL session between reference and target UE.

LMF setups LPP positioning session with multiple UEs and SL session among multiple UEs and obtains both Uu and SL measurements.

Send LS to SA2 on how PRU SL ID can be resolved to SUPI so that LMF can initiate positioning towards such UE.

To implement SL ranging/positioning, discovery procedure is needed to establish PC5 path, thus LMF should be able to retrieve ProSe Capability from AMF if stored, or directly request ProSe Capability from UE. For SL ranging/positioning, the UE capability to transmit SL-PRS, measure and calculate for each detailed SL ranging/positioning method such as RTT, SL-TDOA should also be defined and supported by LPP.
Proposal 1 LPP should support to request and provide 5G ProSe Capability.
Proposal 2 The PC5 Capability for Ranging/SL positioning should be defined, and LPP should support to request and provide PC5 Capability for Ranging/SL positioning.

### 2.2 LMF to UE Protocol Support for Sidelink

The TR 38.859 contains below Options for protocol support for Sidelink between LMF and UE
Extension of LPP, whereby new signaling is to be defined to support hybrid Uu and PC5 based positioning, i.e., extend the existing LPP to support sidelink based positioning between UE and LMF
Enhancement of LPP whereby SLPP signaling can be transported within LPP transparently, i.e., use the newly defined SLPP to support sidelink based positioning and use the existing LPP to support Uu based positioning; and the SLPP is carried as a container in LPP
Use of SLPP between the UE and the LMF

Our view is that we should follow the approach of 1^{st} Option; i.e Extension of LPP to develop the ASN. 1 for now. However, at a later stage depending upon how ASN.1 appears a decision can be made to use container or direct SLPP. Since it is easier to extend the LPP and then considering this baseline evaluate different options.

The baseline for developing ASN.1 to support SL operations between LMF and UE is by means of extension of LPP. The decision whether to use container solution or direct SLPP between UE and LMF is taken after evaluating the baseline extension.

### 2.2.1 Example LPP Extension for SL

RequestCapabilities

The RequestCapabilities message body in a LPP message is used by the location server to request the target device capability information for LPP and the supported individual positioning methods.

-- ASN1START
RequestCapabilities ::= SEQUENCE {

| | |
|---|---|
| criticalExtensions | CHOICE { |
| c1 | CHOICE { |

| | |
|---|---|
| requestCapabilities-r9 | RequestCapabilities-r9-IEs, |

```
      spare3 NULL, spare2 NULL, spare1 NULL
    },
    criticalExtensionsFuture SEQUENCE { }
  }
}
RequestCapabilities-r9-IEs ::= SEQUENCE {
```

| | |
|---|---|
| commonIEsRequestCapabilities | CommonIEsRequestCapabilities |

OPTIONAL, -- Need ON

| | |
|---|---|
| a-gnss-RequestCapabilities | A-GNSS-RequestCapabilities |

OPTIONAL, -- Need ON

| | |
|---|---|
| otdoa-RequestCapabilities | OTDOA-RequestCapabilities |

OPTIONAL, -- Need ON

| | |
|---|---|
| ecid-RequestCapabilities | ECID-RequestCapabilities |

OPTIONAL, -- Need ON

| | |
|---|---|
| epdu-RequestCapabilities | EPDU-Sequence |

```
  OPTIONAL, -- Need ON
  ...,
  [[ sensor-RequestCapabilities-r13 Sensor-RequestCapabilities-r13
  OPTIONAL, -- Need ON
```

| | |
|---|---|
| tbs-RequestCapabilities-r13 | TBS-RequestCapabilities-r13 |

```
  OPTIONAL, -- Need ON
    wlan-RequestCapabilities-r13 WLAN-RequestCapabilities-r13
  OPTIONAL, -- Need ON
```

| | |
|---|---|
| bt-RequestCapabilities-r13 | BT-RequestCapabilities-r13 |

```
  OPTIONAL -- Need ON
  ]],
  [[ nr-ECID-RequestCapabilities-r16 NR-ECID-RequestCapabilities-r16
  OPTIONAL, -- Need ON
    nr-Multi-RTT-RequestCapabilities-r16
```

NR-Multi-RTT-RequestCapabilities-r16

OPTIONAL, -- Need

ON
nr-DL-AoD-RequestCapabilities-r16

NR-DL-AoD-RequestCapabilities-r16 OPTIONAL, -

- Need ON
nr-DL-TDOA-RequestCapabilities-r16

NR-DL-TDOA-RequestCapabilities-r16 OPTIONAL, -

- Need ON

| | |
|---|---|
| nr-UL-RequestCapabilities-r16 | NR-UL-RequestCapabilities-r16 |

```
  OPTIONAL -- Need ON
  ]],
  [[ sl-RTT-RequestCapabilities-r18 SL-RTT-RequestCapabilities-r18
  OPTIONAL -- Need ON
    sl-TDOA-RequestCapabilities-r18 SL-TDOA-RequestCapabilities-r18
  OPTIONAL -- Need ON
    sl-AOA-RequestCapabilities-r18 SL-AOA-RequestCapabilities-r18
  OPTIONAL -- Need ON
  ]]
}
-- ASN1STOP
```

SL-RTT-RequestCapabilities

The IE SL-RTT-RequestCapabilities is used by the location server to request the capability of the target device to support SL-RTT and to request SL-RTT Capabilities from a target device.

-- ASN1START
SL-RTT-RequestCapabilities-r18 ::= SEQUENCE {
...
}
-- ASN1STOP

SL-TDOA-RequestCapabilities

The IE SL-TDOA-RequestCapabilities is used by the location server to request the capability of the target device to support SL-TDOA and to request SL-TDOA Capabilities from a target device.

-- ASN1START
SL-TDOA-RequestCapabilities-r18 ::= SEQUENCE {
...
}
-- ASN1STOP

SL-AoA-RequestCapabilities

The IE SL-AoA-RequestCapabilities is used by the location server to request the capability of the target device to support SL-AoA and to request SL-AoA Capabilities from a target device.

-- ASN1START
SL-AoA-RequestCapabilities-r18 ::= SEQUENCE {
...
}
-- ASN1STOP

ProvideCapabilities

The ProvideCapabilities message body in a LPP message indicates the LPP capabilities of the target device to the location server.

-- ASN1START
ProvideCapabilities ::= SEQUENCE {

| | |
|---|---|
| criticalExtensions | CHOICE { |
| c1 | CHOICE { |

| | |
|---|---|
| provideCapabilities-r9 | ProvideCapabilities-r9-IEs, |

```
      spare3 NULL, spare2 NULL, spare1 NULL
    },
    criticalExtensionsFuture SEQUENCE { }
  }
}
ProvideCapabilities-r9-IEs ::= SEQUENCE {
```

| | |
|---|---|
| commonIEsProvideCapabilities | CommonIEsProvideCapabilities |

OPTIONAL,

| | |
|---|---|
| a-gnss-ProvideCapabilities | A-GNSS-ProvideCapabilities |

OPTIONAL,

| | |
|---|---|
| otdoa-ProvideCapabilities | OTDOA-ProvideCapabilities |

OPTIONAL,

| | |
|---|---|
| ecid-ProvideCapabilities | ECID-ProvideCapabilities |

OPTIONAL,

| | |
|---|---|
| epdu-ProvideCapabilities | EPDU-Sequence |

```
  OPTIONAL,
  ...,
```

| | |
|---|---|
| [[ sensor-ProvideCapabilities-r13 | Sensor-ProvideCapabilities-r13 |

OPTIONAL,

| | |
|---|---|
| tbs-ProvideCapabilities-r13 | TBS-ProvideCapabilities-r13 |

```
  OPTIONAL,
    wlan-ProvideCapabilities-r13 WLAN-ProvideCapabilities-r13
  OPTIONAL,
```

| | |
|---|---|
| bt-ProvideCapabilities-r13 | BT-ProvideCapabilities-r13 |

```
  OPTIONAL
  ]],
  [[ nr-ECID-ProvideCapabilities-r16 NR-ECID-ProvideCapabilities-r16
  OPTIONAL,
    nr-Multi-RTT-ProvideCapabilities-r16
```

NR-Multi-RTT-ProvideCapabilities-r16

```
  OPTIONAL,
    nr-DL-AoD-ProvideCapabilities-r16
```

NR-DL-AoD-ProvideCapabilities-r16

```
  OPTIONAL,
    nr-DL-TDOA-ProvideCapabilities-r16
```

NR-DL-TDOA-ProvideCapabilities-r16

OPTIONAL,

| | |
|---|---|
| nr-UL-ProvideCapabilities-r16 | NR-UL-ProvideCapabilities-r16 |

```
  OPTIONAL
  ]],
  [[ sl-RTT-ProvideCapabilities-r18 SL-RTT-ProvideCapabilities-r18
  OPTIONAL,
    sl-TDOA-ProvideCapabilities-r18 SL-TDOA-ProvideCapabilities-r18
  OPTIONAL,
    sl-AoA-ProvideCapabilities-r18 SL-AoA-ProvideCapabilities-r18
  OPTIONAL
  ]]
}
-- ASN1STOP
```

SL-RTT-ProvideCapabilities

The IE SL-RTT-ProvideCapabilities is used by the target device to indicate its capability to support SL-RTT and to provide its SL-RTT for positioning capabilities to the location server.

-- ASN1START
SL-RTT-ProvideCapabilities-r18 ::= SEQUENCE {
...
}
-- ASN1STOP

SL-TDOA-ProvideCapabilities

The IE SL-TDOA-ProvideCapabilities is used by the target device to indicate its capability to support SL-TDOA and to provide its SL-TDOA for positioning capabilities to the location server.

-- ASN1START
SL-TDOA-ProvideCapabilities-r18 ::= SEQUENCE {
...
}
-- ASN1STOP

SL-AoA-ProvideCapabilities

The IE SL-AoA-ProvideCapabilities is used by the target device to indicate its capability to support SL-AoA and to provide its SL-AoA for positioning capabilities to the location server.

-- ASN1START
SL-AoA-ProvideCapabilities-r18 ::= SEQUENCE {
...
}
-- ASN1STOP

### 2.2.2.2 AD Request and Provide

RequestAssistanceData

The RequestAssistanceData message body in a LPP message is used by the target device to request assistance data from the location server.

-- ASN1START
RequestAssistanceData ::= SEQUENCE {

| criticalExtensions | | CHOICE { |
|---|---|---|
| | c1 | CHOICE { |

```
  requestAssistanceData-r9 RequestAssistanceData-r9-IEs,
  spare3 NULL, spare2 NULL, spare1 NULL
},
criticalExtensionsFuture SEQUENCE { }
```

}
}
RequestAssistanceData-r9-IEs ::= SEQUENCE {

| | |
|---|---|
| commonIEsRequestAssistanceData | CommonIEsRequestAssistanceData |

OPTIONAL,

| | |
|---|---|
| a-gnss-RequestAssistanceData | A-GNSS-RequestAssistanceData |

OPTIONAL,

| | |
|---|---|
| otdoa-RequestAssistanceData | OTDOA-RequestAssistanceData |

OPTIONAL,

| | |
|---|---|
| epdu-RequestAssistanceData | EPDU-Sequence |

```
  OPTIONAL,
  ...,
```

| | |
|---|---|
| [[ | sensor-RequestAssistanceData-r14 |

Sensor-RequestAssistanceData-r14

OPTIONAL,

| | |
|---|---|
| tbs-RequestAssistanceData-r14 | TBS-RequestAssistanceData-r14 |

OPTIONAL,

| | |
|---|---|
| wlan-RequestAssistanceData-r14 | WLAN-RequestAssistanceData-r14 |

```
  OPTIONAL
  ]],
```

| | |
|---|---|
| [[ | nr-Multi-RTT-RequestAssistanceData-r16 NR-Multi-RTT- |

RequestAssistanceData-r16 OPTIONAL,

| | |
|---|---|
| nr-DL-AoD-RequestAssistanceData-r16 | NR-DL-AoD- |

| | |
|---|---|
| RequestAssistanceData-r16 | OPTIONAL, |

| | |
|---|---|
| nr-DL-TDOA-RequestAssistanceData-r16 | NR-DL-TDOA- |

RequestAssistanceData-r16 OPTIONAL
]],

| [[ | sl-RTT-RequestAssistanceData-r18 | SL-RTT-RequestAssistanceData- |
|---|---|---|
| r18 | OPTIONAL, | |
| | sl-TDOA-RequestAssistanceData-r18 | SL-TDOA-RequestAssistanceData- |
| r18 | OPTIONAL, | |
| | sl-AoA-RequestAssistanceData-r18 | SL-AoA-RequestAssistanceData- |

| | |
|---|---|
| r18 | OPTIONAL, |

]]
}
-- ASN1STOP

SL-RTT-RequestAssistanceData

The IE SL-RTT-RequestAssistance Data is used by the device to request assistance data from a location server.

-- ASN1START
SL-RTT-RequestAssistanceData-r18 : : = SEQUENCE {
. . .
}
-- ASN1STOP

SL-RTT-RequestAssistanceData

The IE SL-TDOA-RequestAssistanceData is used by the device to request assistance data from a location server.

-- ASN1START
SL-TDOA-RequestAssistanceData-r18 : : = SEQUENCE {
. . .
}
-- ASN1STOP

SL-AoA-RequestAssistanceData

The IE SL-AoA-RequestAssistance Data is used by the device to request assistance data from a location server.

-- ASN1START
SL-AoA-RequestAssistanceData-r18 : : = SEQUENCE {
. . .
}
-- ASN1STOP

ProvideAssistanceData

The Provide AssistanceData message body in a LPP message is used by the location server to provide assistance data to the target device either in response to a request from the target device or in an unsolicited manner.

-- ASN1START
ProvideAssistanceData : : = SEQUENCE {

| | |
|---|---|
| criticalExtensions | CHOICE { |
| c1 | CHOICE { |

```
      provideAssistanceData-r9 ProvideAssistanceData-r9-IEs,
      spare3 NULL, spare2 NULL, spare1 NULL
    },
    criticalExtensionsFuture SEQUENCE { }
  }
}
ProvideAssistanceData-r9-IEs : : = SEQUENCE {
```

| | |
|---|---|
| commonIEsProvideAssistanceData | CommonIEsProvideAssistanceData |
| OPTIONAL, -- Need ON | |
| a-gnss-ProvideAssistanceData | A-GNSS-ProvideAssistanceData |
| OPTIONAL, -- Need ON | |
| otdoa-ProvideAssistanceData | OTDOA-ProvideAssistanceData |
| OPTIONAL, -- Need ON | |
| epdu-Provide-Assistance-Data | EPDU-Sequence |

```
  OPTIONAL, -- Need ON
  . . . ,
  [ [
```

| | |
|---|---|
| sensor-ProvideAssistanceData-r14 | Sensor-ProvideAssistanceData-r14 |
| OPTIONAL, -- Need ON | |
| tbs-ProvideAssistanceData-r14 | TBS-ProvideAssistanceData-r14 |
| OPTIONAL, -- Need ON | |
| wlan-ProvideAssistanceData-r14 | WLAN-ProvideAssistanceData-r14 |

```
  OPTIONAL -- Need ON
  ] ] ,
  [ [ nr-Multi-RTT-ProvideAssistanceData-r16
        NR-Multi-RTT-ProvideAssistanceData-r16
OPTIONAL, --
Need ON
    nr-DL-AoD-ProvideAssistanceData-r16
        NR-DL-AoD-ProvideAssistanceData-r16
OPTIONAL, -- Need ON
    nr-DL-TDOA-ProvideAssistanceData-r16
        NR-DL-TDOA-ProvideAssistanceData-r16
                                    OPTIONAL --
Need ON
  ] ] ,
  [ [ sl-RTT-ProvideAssistanceData-r18
        SL-RTT-ProvideAssistanceData-r18
  OPTIONAL, -- Need ON
    sl-TDOA-ProvideAssistanceData-r18
        SL-TDOA-ProvideAssistanceData-r18
  OPTIONAL, -- Need ON
    sl-AoA-ProvideAssistanceData-r18
        SL-AoA-ProvideAssistanceData-r18  OPTIONAL
  -- Need ON
  ] ]
}
-- ASN1STOP
```

SL-RTT-ProvideAssistanceData

The IE SL-RTT-Provide Assistance Data is used by the location server to provide assistance data to enable SL-RTT.

-- ASN1START
SL-RTT-ProvideAssistanceData-r18 : : = SEQUENCE {
. . .
}
-- ASN1STOP

SL-TDOA-ProvideAssistanceData

The IE SL-TDOA-Provide AssistanceData is used by the location server to provide assistance data to enable SL-TDOA.

-- ASN1START
SL-TDOA-ProvideAssistanceData-r18 : : = SEQUENCE {
. . .
}
-- ASN1STOP

SL-AoA-ProvideAssistanceData

The IE SL-AoA-Provide Assistance Data is used by the location server to provide assistance data to enable SL-AoA.

-- ASN1START
SL-AoA-ProvideAssistanceData-r18 : : = SEQUENCE {
. . .
}
-- ASN1STOP

### 2.2.2.3 Location Information Request and Provide

RequestLocationInformation

The RequestLocationInformation message body in a LPP message is used by the location server to request positioning measurements or a position estimate from the target device.

-- ASN1START
RequestLocationInformation : : = SEQUENCE {

| | |
|---|---|
| criticalExtensions | CHOICE { |
| c1 | CHOICE { |

```
      requestLocationInformation-r9 RequestLocationInformation-r9-
IEs,
      spare3 NULL, spare2 NULL, spare1 NULL
    },
    criticalExtensionsFuture SEQUENCE { }
  }
}
RequestLocationInformation-r9-IEs : : = SEQUENCE {
  commonIEsRequestLocationInformation
      CommonIEsRequestLocationInformation
```

| | |
|---|---|
| OPTIONAL, -- Need ON | |
| a-gnss-RequestLocationInformation | A-GNSS-RequestLocationInformation |
| OPTIONAL, -- Need ON | |
| otdoa-RequestLocationInformation | OTDOA-RequestLocationInformation |
| OPTIONAL, -- Need ON | |
| ecid-RequestLocationInformation | ECID-RequestLocationInformation |
| OPTIONAL, -- Need ON | |
| epdu-RequestLocationInformation | EPDU-Sequence |
| OPTIONAL, -- Need ON | |
| . . . , | |
| [ [ | |

```
  sensor-RequestLocationInformation-r13
      Sensor-RequestLocationInformation-r13
OPTIONAL, --
```

| | |
|---|---|
| Need ON | |
| tbs-RequestLocationInformation-r13 | TBS-RequestLocationInformation-r13 |
| OPTIONAL, -- Need ON | |
| wlan-RequestLocationInformation-r13 | WLAN-RequestLocationInformation-r13 |
| OPTIONAL, -- Need ON | |
| bt-RequestLocationInformation-r13 | BT-RequestLocationInformation-r13 |
| OPTIONAL -- Need ON | |
| ] ] , | |

```
  [ [ nr-ECID-RequestLocationInformation-r16
      NR-ECID-RequestLocationInformation-r16
OPTIONAL, --
Need ON
    nr-Multi-RTT-RequestLocationInformation-r16
      NR-Multi-RTT-RequestLocationInformation-r16
OPTIONAL, --
Need ON
    nr-DL-AoD-RequestLocationInformation-r16
      NR-DL-AoD-RequestLocationInformation-r16
OPTIONAL, --
Need ON
    nr-DL-TDOA-RequestLocationInformation-r16
      NR-DL-TDOA-RequestLocationInformation-r16
OPTIONAL --
Need ON
  ]] ,
  [ [ sl-RTT-RequestLocationInformation-r18
      SL-RTT-RequestLocationInformation-r18
OPTIONAL, --
Need ON
    sl-TDOA-RequestLocationInformation-r18
      SL-TDOA-RequestLocationInformation-r18
OPTIONAL, --
Need ON
    sl-AoA-RequestLocationInformation-r18
      SL-AoA-RequestLocationInformation-r18
OPTIONAL --
Need ON
  ] ]
}
-- ASN1STOP
```

SL-RTT-RequestLocationInformation

The IE SL-RTT-RequestLocationInformation is used by the location server to request SL-RTT location measurements from a device.

-- ASN1START
SL-RTT-RequestLocationInformation-r18 : : = SEQUENCE {
. . .
}
-- ASN1STOP

SL-TDOA-RequestLocationInformation

The IE SL-TDOA-RequestLocationInformation is used by the location server to request SL-TDOA location measurements from a device.

-- ASN1START
SL-TDOA-RequestLocationInformation-r18 : : = SEQUENCE {
. . .
}
-- ASN1STOP

SL-AoA-RequestLocationInformation

The IE SL-AoA-RequestLocationInformation is used by the location server to request SL-AoA location measurements from a device.

-- ASN1START
SL-AoA-RequestLocationInformation-r18 : : = SEQUENCE {
. . .
}
-- ASN1STOP

ProvideLocationInformation

The ProvideLocationInformation message body in a LPP message is used by the target device to provide positioning measurements or position estimates to the location server.

-- ASN1START
ProvideLocationInformation : : = SEQUENCE {

| | |
|---|---|
| criticalExtensions | CHOICE { |
| c1 | CHOICE { |

| | |
|---|---|
| provideLocationInformation-r9 | ProvideLocationInformation-r9- |

```
IEs,
      spare3 NULL, spare2 NULL, spare1 NULL
    },
    criticalExtensionsFuture SEQUENCE { }
  }
}
ProvideLocationInformation-r9-IEs : : = SEQUENCE {
  commonIEsProvideLocationInformation
          CommonIEsProvideLocationInformation
```

| | |
|---|---|
| OPTIONAL, | |
| a-gnss-ProvideLocationInformation | A-GNSS-ProvideLocationInformation |
| OPTIONAL, | |
| otdoa-ProvideLocationInformation | OTDOA-ProvideLocationInformation |
| OPTIONAL, | |
| ecid-ProvideLocationInformation | ECID-ProvideLocationInformation |
| OPTIONAL, | |
| epdu-ProvideLocationInformation | EPDU-Sequence |
| OPTIONAL, | |
| . . . , | |
| [ [ | |

```
  sensor-ProvideLocationInformation-r13
          Sensor-ProvideLocationInformation-r13
                                    OPTIONAL,
```

| | |
|---|---|
| tbs-ProvideLocationInformation-r13 | TBS-ProvideLocationInformation-r13 |
| OPTIONAL, | |
| wlan-ProvideLocationInformation-r13 | WLAN-ProvideLocationInformation-r13 |
| OPTIONAL, | |
| bt-ProvideLocationInformation-r13 | BT-ProvideLocationInformation-r13 |
| OPTIONAL | |
| ] ] , | |

```
  [ [ nr-ECID-ProvideLocationInformation-r16
        NR-ECID-ProvideLocationInformation-r16
  OPTIONAL,
    nr-Multi-RTT-ProvideLocationInformation-r16
        NR-Multi-RTT-ProvideLocationInformation-r16
  OPTIONAL,
    nr-DL-AoD-ProvideLocationInformation-r16
        NR-DL-AoD-ProvideLocationInformation-r16
  OPTIONAL,
    nr-DL-TDOA-ProvideLocationInformation-r16
        NR-DL-TDOA-ProvideLocationInformation-r16
  OPTIONAL
  ] ] ,
  [ [ sl-RTT-ProvideLocationInformation-r18
          SL-RTT-ProvideLocationInformation-r18
OPTIONAL, --
Need ON
    sl-TDOA-ProvideLocationInformation-r18
          SL-TDOA-ProvideLocationInformation-r18
OPTIONAL, --
Need ON
    sl-AoA-ProvideLocationInformation-r18
          SL-AoA-ProvideLocationInformation-r18
OPTIONAL --
Need ON
  ] ]
}
-- ASN1STOP
```

SL-RTT-ProvideLocationInformation

The IE SL-RTT-ProvideLocationInformation is used by the target device to provide SL-RTT location measurements to the location server. It may also be used to provide SL-RTT positioning specific error reason.

-- ASN1START
SL-RTT-ProvideLocationInformation-r18 : : = SEQUENCE {
. . .
}
-- ASN1STOP

SL-TDOA-ProvideLocationInformation

The IE SL-TDOA-ProvideLocationInformation is used by the target device to provide SL-TDOA location measurements to the location server. It may also be used to provide SL-TDOA positioning specific error reason.

-- ASN1START
SL-TDOA-ProvideLocationInformation-r18 : : = SEQUENCE {
. . .
}
-- ASN1STOP

SL-RTT-ProvideLocationInformation

The IE SL-AoA-ProvideLocationInformation is used by the target device to provide SL-AoA location measurements to the location server. It may also be used to provide SL-AoA positioning specific error reason.

-- ASN1START
SL-AoA-ProvideLocationInformation-r18 : : = SEQUENCE {
. . .
}
-- ASN1STOP

### 2.3 SLPP Protocol Stack Discussion

RAN2 need to decide which approach to take for placement of SLPP in the protocol stack. There are two options:
Option 1) on top of PDCP
Option 2) SL-DRB, Similar to V2X

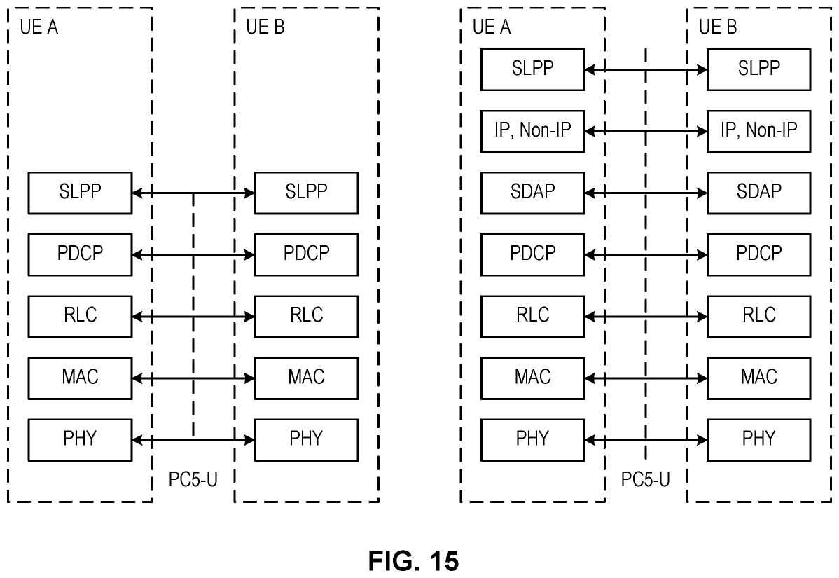

FIG. 15 illustrates an example protocol stack.

2.4 SL Ranging Measurements when Synch Source or Coverage Changes

For SL positioning/ranging measurements, accurate synchronisation is essential. The sidelink synchronization reference source can change for different reasons, e.g. due to UE mobility, channel conditions etc., while UE is performing SL positioning measurements which may lead inaccurate measurements. How would UE cope when the synch source during positioning measurement changes? Additionally, another question would be: UEs may be (pre) configured or have pre-allocated resources to perform SL ranging measurements in different coverage scenario (IC, PC, OOC). A group of UEs (at least 2 UEs; e.g. car platooning) may perform ranging continuously; however in the coverage crossing area (IC to OOC or vice versa) where UEs may have performed the measurement in one coverage but now happen to be in different coverage; would the ongoing measurements be valid? The impact on change of coverage and synchronization reference source while performing the SL positioning measurements needs to be investigated.

The Synchronization and measurement validity are RAN4 related question which should be provided by RAN4. Depending upon the outcome of the results, the SL procedure would have impact, such as whether to continue the SL procedure or restart the procedure.

Send LS to RAN4 requesting how would the ongoing SL measurements be impacted when the synch source changes and/or coverage status changes.

### 2.5 Discovery Procedure for SL Positioning

In SL positioning, target UE and/or anchor UE(s) transmits and/or measures SL-PRS. The target UE expected to reuse the existing ProSe discovery procedures to find potential anchor UEs. Unlike in SL communication where the discovered UE(s) is usually the designated receiver(s) to consume the SL communication message, the anchor UE(s) in SL positioning are instead expected to measure (and transmit) SL-PRS thus in this sense all the nearby UEs seems to have the potential to act as anchor UE(s). However, depending on the use case, the SL positioning/ranging sessions are imposed with different positioning QoS requirements. Such QoS requirements would further require the selected assisting UEs to be capable of providing SL transmissions or receptions according to the QoS requirement for the corresponding SL positioning/ranging sessions/services.

However, there is no mechanism to support indicating positioning QoS requirement in the current ProSe Discovery process for SL positioning/ranging, and this may lead to unsatisfied QoS with degraded positioning accuracy and/or latency, and waste of resources. For example, a target UE cannot indicate the QoS requirements of the SL positioning services/sessions to its neighbor UEs (e.g., potential anchor UEs). Without such information, its neighbor UEs would not be able to decide whether they fulfill the QoS requirements of the SL positioning sessions/services. A neighbor UE which is not suitable may provide a discovery response message to the target UE by mistake (wrong selection). The target UE may therefore select this neighbor UE as one anchor UE by mistake (wrongly). The wrong selection of anchor UE(s) may cause SL positioning QoS requirement not satisfied and/or anchor UE(s) reselection that cause resource waste and longer latency.

The current ProSe Discovery process does not support indicating positioning QoS requirement in for SL positioning/ranging, and this may lead to unsatisfied QoS with degraded positioning accuracy and/or latency, and waste of resources.

Inform SA2 via LS that indicating positioning QoS requirement for SL positioning/ranging is supported in the ProSe Discovery process.

### 2.6 Overhearing

### 2.6.1 gNB Overhearing SL-PRS

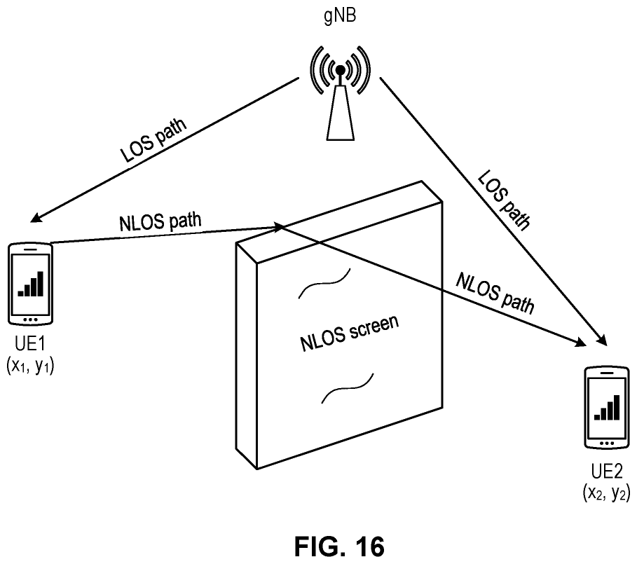

FIG. 16 illustrates an example scenario where two UEs in a ranging session are in NLOS, while gNB has LOS condition to the UEs.

As part of the Rel-18 work item on sidelink (SL) positioning, a new SL positioning reference signal (SL-PRS) will be specified to be used for measurements between UEs. For in-coverage (IC) scenario, it would benefit if base station is also involved in the ranging/SL positioning process with the below cases
In a ranging session the UEs have NLOS condition, and a gNB has LOS condition to the UEs as shown in FIG. 16.
As the coverage of sidelink is limited and furthermore there may not be several UEs available to be involved for ranging measurements, then it is better the base station is involved.

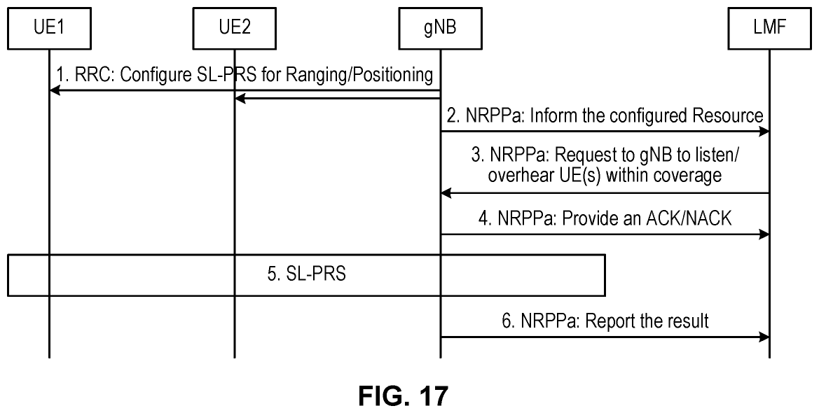

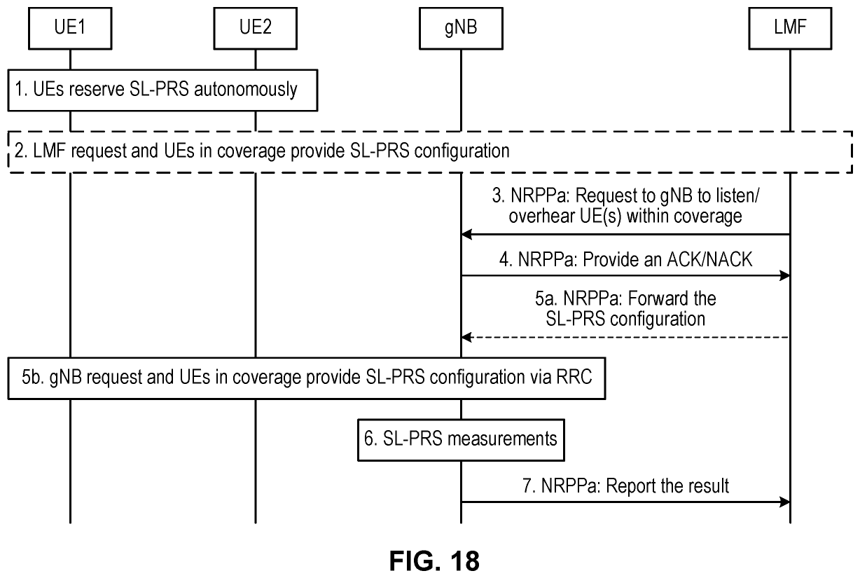

For the above cases, having gNB taking measurements will improve the ranging/SL positioning accuracy. Moreover, in IC scenario SL-PRS is audible to the gNB, it is resource-efficient for gNB to measure (overhear) on SL-PRS instead of configure UL-SRS. FIG. 17 and FIG. 18 show the mechanism of gNB overhear SL-PRS for the two resource allocation schemes respectively. From FIG. 17 when the SL-PRS is configured by gNB, gNB overhearing SL-PRS cause no extra overhead to the UEs. In FIG. 18, when SL-PRS is autonomously reserved by the UEs, gNB overhearing SL-PRS requires the UEs to sends its SL-PRS configuration to LMF and gNB, which still saves more energy compared to set up Uu measurement with gNB separately.

FIG. 17 illustrates a gNB listen/overhear SL-PRS by Scheme 1.

The steps in FIG. 17 are as follows:
Step 1: gNB configures SL-PRS for UE(s) within coverage for ranging or positioning purpose. The gNB may receive the request to configure such via LMF.
Step 2: gNB reports the configured resource(s) to LMF.
Step 3: LMF request gNB to measure on SL-PRS transmitted by UE(s) within coverage. Such measurements may act as extra measurements or replace SRS measurements in the multi-RTT or hybrid SL-TDOA procedures.
Step 4: gNB reply to the request by LMF.
Step 5: gNB measures SL-PRS transmitted by the UE(s) within coverage.
Step 6: gNB send the measurement result(s) to LMF.

FIG. 18 illustrates a gNB listen/overhear SL-PRS by Scheme 2.

The steps in FIG. 18 are as follows:
Step 1: UEs performing SL positioning/ranging reserve SL-PRS autonomously.
Step 2: Optionally, LMF may request for UEs that are in coverage to send their SL-PRS configuration, and UEs provide LMF the SL-PRS configuration.
Step 3: LMF request gNB to measure SL-PRS transmitted by the UEs that is in coverage. Such measurements may act as extra measurements or replace SRS measurements in the multi-RTT or hybrid SL-TDOA procedures.
Step 4: gNB reply to the request of LMF.
Step 5: LMF may forward the SL-PRS configuration to gNB, or gNB request UEs directly for the SL-PRS configuration.
Step 6: gNB measures SL-PRS transmitted by the UE within coverage.
Step 7: gNB send the measurement results to LMF.

gNB overhearing SL-PRS benefit the ranging/SL positioning accuracy causing no or little overhead to the UEs.

gNB overhearing SL-PRS is supported.

### 3 Conclusion

Observation 1 LPP session should be extended such that multiple UEs can join the positioning session with LMF and allow LMF to perform hybrid Positioning. LPP with signalling procedures for SL ranging/positioning which is used at Uu interface between LMF and UE should also support SL UE to UE operations.
Observation 2 The current ProSe Discovery process does not support indicating positioning QoS requirement in for SL positioning/ranging, and this may lead to unsatisfied QoS with degraded positioning accuracy and/or latency, and waste of resources.
Observation 3 gNB can compute (synthetic) range between two UEs based on absolute positioning of the two UEs. This can be used to verify or improve direct ranging between the two UEs.
Observation 4 Assistance data can be used to make an intelligent selection of anchor UEs for a target UE. This can give higher positioning performance and more efficient spectrum usage.
Observation 5 Assistance information about neighbors of a candidate anchor UE can guide the target UE to find additional anchor UEs to perform sidelink positioning measurements with.

Based on the discussion in the previous sections we propose the following:
Proposal 1 LPP session between UE and NW is extended to support UE to UE SL Operations and to allow LMF to execute hybrid Positioning procedures by obtaining Uu and SL measurements
Proposal 2 The target UE shall discover a reference UE/PRU and report to LMF and LMF setups LPP positioning session with the reference UE/PRU and SL session between reference and target UE.
Proposal 3 LMF setups LPP positioning session with multiple UEs and SL session among multiple UEs and obtains both Uu and SL measurements.
Proposal 4 Send LS to SA2 on how PRU SL ID can be resolved to SUPI so that LMF can initiate positioning towards such UE.
Proposal 7 The baseline for developing ASN. 1 to support SL operations between LMF and UE is by means of extension of LPP. The decision whether to use container solution or direct SLPP between UE and LMF is taken after evaluating the baseline extension.
Proposal 8 Send LS to RAN4 requesting how would the ongoing SL measurements be impacted when the synch source changes and/or coverage status changes.
Proposal 9 Inform SA2 via LS that indicating positioning QoS requirement for SL positioning/ranging is supported in the ProSe Discovery process.
Proposal 10 gNB overhearing SL-PRS is supported.

### APPENDIX B

### Introduction

RAN #98e approved Rel. 18 WID with the following objectives [1]:
Specify solutions for support of sidelink positioning (including ranging) in NR systems.
Specify enhancements for enabling LPHAP use-case 6 as defined in TS 22.104.
Specify support of positioning for UEs with Reduced Capabilities (RedCap UEs).
Specify bandwidth aggregation for positioning measurements across up to three intra-band contiguous carriers.
Specify physical layer measurements and signalling to support NR DL and UL carrier phase positioning for UE-based, UE-assisted, and NG-RAN node assisted positioning.

In this contribution we present our views on:
SL positioning core requirements
LPHAP core requirements
RedCap positioning core requirements
PRS/SRS aggregation core requirements
Carrier phase positioning core requirements Discussion

### LPHAP Core Requirements

Rel. 18 WID outlines the following objectives for LPHAP:
Specify enhancements for enabling LPHAP use-case 6 as defined in TS 22.104 including:
   Extending eDRX cycle beyond 10.24s in RRC_INACTIVE state towards meeting the battery life requirement for LPHAP [RAN2, RAN3, RAN4]
      Positioning-specific enhancement for eDRX cycle beyond 10.24s to be defined as part of Rel-18 WI on expanded and improved NR positioning.
         NOTE: Work on this objective should be coordinated with that in Rel-18 WI on eRedCap. Towards this, the feature of extending eDRX cycle beyond 10.24s should be defined as part of Rel-18 WI on eRedCap.
      NOTE: Inputs from RAN1 as necessary may be facilitated via LSs
   For UL and DL+UL positioning for UEs in RRC_INACTIVE state, specify SRS configuration enhancements based on SRS positioning validity area to avoid frequent RRC connection for SRS (re) configuration [RAN2, RAN1, RAN3].
      SRS for positioning configurations in multiple cells [RAN2, RAN1].
         Note: Details including issues such as interference, timing advance, spatial relation information, pathloss reference and common SRS parameters across multiple cells can be further discussed during normative work.
      Pre-configuration of one or multiple SRS for positioning configurations [RAN2, RAN3].
      SRS for positioning activation/request procedure(s) [RAN2, RAN1].
   Specify solutions for DL PRS measurements for a UE in RRC_IDLE state and reporting of the measurements in RRC_CONNECTED state [RAN2].
   Specify solutions for alignment between eDRX and PRS configurations [RAN2].
   Specify corresponding new core requirements, as well as identifying and specifying the impact on the existing RAN4 specification, including RRM measurements and procedures [RAN4].

In Rel. 17 positioning in RRC_INACTIVE state was introduced. To support positioning in RRC_INACTIVE state Rel. 17 WI concluded by defining core and performance requirements (Note: some minor issues are yet to be settled and will be handled as maintenance) for DRX. Rel. 18 SI on positioning concluded that the existing Rel. 17 positioning in RRC_INACTIVE state cannot satisfy the target battery life required by LPHAP use cases. To achieve target battery life, eDRX cycle that is extended beyond 10.24s is needed to allow UE to remain in deep sleep state for a longer period of time. To address such a need one of the objectives of Rel. 18 WI is to define requirements for positioning measurements based on eDRX cycle beyond 10.24s. TS38.133 has specified eDRX based requirements only for RedCap UEs. Therefore, to support LPHAP use cases, RAN4 should discuss and extend core requirements based on eDRX for legacy UEs performing positioning measurements in RRC_INACTIVE state.
Observation 1: eDRX based requirements are only defined for RedCap UEs.
Proposal 1: RAN4 to define positioning core requirements based on eDRX.

One of the other objectives is to specify solutions for DL-PRS measurements for a UE in RRC_IDLE state. TS38.215 defines applicability of positioning measurements (DL-RSTD, DL PRS-RSRPP, DL PRS-RSRP, and UE Rx-Tx time difference) to only RRC_CONNECTED and RRC_INACTIVE modes. If the positioning measurements applicability is extended to RRC_IDLE mode by RAN1 then RAN4 shall introduce core requirements applicable for RRC_IDLE mode.
Observation 2: Positioning measurements (DL-RSTD, DL PRS-RSRPP, DL PRS-RSRP, and UE Rx−Tx time difference) are applicable for RRC_CONNECTED and RRC_INACTIVE modes only.
Proposal 2: Define core requirements for RRC_IDLE mode after the applicability of positioning measurements (DL-RSTD, DL PRS-RSRPP, DL PRS-RSRP, and UE Rx−Tx time difference) is extended to RRC_IDLE mode.

### RedCap Positioning Core Requirements

Specify support of positioning for UEs with Reduced Capabilities (RedCap UEs)
   Specify support of Frequency Hopping (FH) beyond maximum RedCap UE bandwidth for reception of DL PRS and transmission of UL SRS for positioning [RAN1, RAN2].
      NOTE: The complexity of the corresponding capabilities for RedCap UEs should be addressed for the introduction of appropriate capabilities for RedCap UEs.
   Specify RRM requirements for positioning including RRM measurements and procedures for RedCap UEs for both with and without frequency hopping [RAN4].

Positioning of RedCap UEs was one of the items studied during Rel. 18 SI. Based on the conclusions from the SI the following observations can be made:
Rel. 17 solutions cannot meet horizontal accuracy requirement for industrial IIoT use cases.
The main limitation comes from the limited bandwidth supported by RedCap UEs (20 MHz in FR1 and 100 MHz in FR2).

To enhance achievable positioning accuracy by RedCap UEs Rel. 18 has an objective to specify support of positioning for RedCap UEs with frequency hopping beyond the maximum RedCap UE bandwidth for reception of DL PRS and transmission of UL SRS for positioning. Since there is no requirement defined for RedCap UEs for positioning measurements, RAN4 shall begin by discussing/defining requirements for positioning measurements for RedCap UEs without frequency hopping first and then specify RRM requirements for positioning measurements with frequency hopping after the positioning framework/procedure with frequency hopping is settled in RAN1/RAN2. To define the core requirements without hopping, RAN4 can reuse Rel. 17 requirements to define core requirements for RedCap UE positioning in RRC_CONNECTED and RRC_INACTIVE states without hopping. To ensure less impact on performance life of battery in RedCap devices, due to positioning measurements, the positioning requirements can be further extended to RRC_IDLE mode.
Proposal 3: Reuse Rel. 17 core requirements to define core requirements for RedCap UE positioning in RRC_CONNECTED state and RRC_INACTIVE state for 2Rx RedCap UE for FDD/TDD without frequency hopping.
Proposal 4: RAN4 to study and identify core requirements for RedCap UE positioning in RRC_CONNECTED state and RRC_INACTIVE state for 1Rx RedCap FDD/TDD UEs without frequency hopping.
Proposal 5: RAN4 to study and identify core requirement for 1Rx and 2Rx RedCap UEs in RRC_IDLE mode for positioning measurements without frequency hopping.
Proposal 6: RAN4 to study and identify core requirements for 1Rx and 2Rx RedCap UE positioning with frequency hopping after framework/procedure for frequency hopping for positioning is concluded by RAN1/RAN2.
Proposal 7: RAN4 to study and identify core requirement for HD-FDD RedCap UEs (including 1Rx and 2Rx UEs).

### PRS/SRS Aggregation Core Requirements

Specify bandwidth aggregation for positioning measurements across up to three intra-band contiguous carriers [RAN1, RAN2, RAN4].
   Specify signalling and procedures to support aggregation of PRS/SRS (respectively) resources across PFLs/carriers (respectively) for positioning measurements under the assumption that the signals over aggregated resources are transmitted and received (respectively) using a single RF chain (same antenna) [RAN1, RAN2].
      NOTE: The support of bandwidth aggregation for positioning measurements applies only to timing related measurements (e.g., RSTD, RTOA, and UE/gNB Rx-Tx time difference).
   Specify RRM requirements with measurement gaps in connected mode, and in inactive mode, including PRS measurement period/reporting [RAN4].

As a part of Rel. 18 SI, RAN4 studied the feasibility aspects of bandwidth aggregation for positioning measurements. Based on the study, bandwidth aggregation for intra-band contiguous carriers is concluded as feasible for single chain Tx/Rx architectures at both UE and gNB. Taking RAN4 conclusions into account Rel. 18 WID has an objective on RAN1/RAN2 to specify signalling and procedures to support bandwidth aggregation for positioning measurements and an objective on RAN4 to specify RRM requirements.

Depending on multicarrier positioning capability (MCPC) a UE may be configured to perform positioning measurements by aggregating PRS resource(s) from multiple PFLs. UE in this case depending on multicarrier communication capability (MCCC) and MCPC can either be configured to only perform MC positioning measurements or UE can also be configured to perform MC operation for communication (i.e. CA/DC) in parallel to ongoing MC positioning measurements. Depending on how UE is configured to perform MC positioning measurements, different core requirements may apply. For example, if UE is configured only to perform MC positioning measurements the core requirement that apply in this case can be different in comparison to the scenario when UE is configured to simultaneously perform MC operation for communication and MC positioning measurements.
Observation 3: Depending on how UE is configured to perform MC positioning measurements different core requirements apply.
Proposal 8: RAN4 to define core requirements when UE is configured only to perform MC positioning measurements without performing MC operation for communication in RRC INACTIVE state and RRC_CONNECTED state.
Proposal 9: RAN4 to define core requirements when UE is configured to simultaneously perform MC operation for communication and MC positioning measurement in RRC CONNECTED state.

### Carrier Phase Positioning Core Requirements

Specify physical layer measurements and signalling to support NR DL and UL carrier phase positioning for UE-based, UE-assisted, and NG-RAN node assisted positioning [RAN1, RAN2, RAN3, RAN4].
   Existing DL PRS and UL SRS for positioning are used for NR carrier phase measurements.
   Specify measurements that are limited to a single carrier/PFL.
   Specify corresponding new core requirements, as well as identifying and specifying the impact on the existing RAN4 specification, including RRM measurements without measurement gaps in connected and inactive mode (including PRS measurement period/reporting) and procedures [RAN4].

TR38.859 recommends carrier phase as one of the new measurements that shall be introduced during Rel. 18 normative work to support UE-based and UE-assisted NR carrier phase positioning (CPP). The detail procedure/framework for CPP is yet to be finalized by the leading WGs. If the carrier phase is defined as a complimentary measurement that is performed by UE on PRS resource(s) together with the existing positioning measurements, then there shall be no impact on the core requirement. However, if the carrier phase is defined as a new measurement, then RAN4 shall evaluate impact on core requirements.
Proposal 10: No impact on core requirement if carrier phase is defined as a complimentary measurement that is performed by UE on PRS resource(s) together with the existing positioning measurements.
Proposal 11: RAN4 to evaluate impact on core requirement if carrier phase is defined as a new measurement by RAN1/RAN2.

### SL Positioning Requirements

The following objectives have been specified for SL positioning [1]:
Core part:
   Specify solutions for support of sidelink positioning (including ranging) in NR systems, including the following [RAN1, RAN2, RAN3, RAN4]:
      Specify SL PRS for support of sidelink positioning such that the SL PRS uses a comb-based (full RE mapping pattern is not precluded) frequency domain structure and a pseudorandom-based sequence where the existing sequence of DL-PRS is used as a starting point [RAN1].
         Specify support for SL PRS bandwidths of up to 100 MHz in FRI spectrum.
         NOTE: SL PRS transmission in FR2 is not precluded but no FR2 specific aspects will be specified.
      Specify measurements to support RTT-type solutions using SL, SL-AoA, and SL-TDOA [RAN1, RAN2].
      Specify support of resource allocation for SL PRS:
         Including resource allocation Scheme 1 and Scheme 2, where Scheme 1 corresponds to a network-centric SL PRS resource allocation and Scheme 2 corresponds to UE autonomous SL PRS resource allocation [RAN1].
         For resource allocation mechanism for SL PRS in Scheme 2:
         Study and specify support of sensing-based resource allocation, and/or a random resource selection [RAN1].
         Study and specify solutions for congestion control for SL PRS and/or inter-UE coordination for SL-PRS [RAN1].
         Support resource allocation for shared resource pool with Rel-16/17/18 sidelink communication and dedicated resource pool for SL PRS [RAN1].
         NOTE: For SL positioning resource (pre-) configuration in a shared resource pool with Rel-16/17/18 sidelink communication, backward compatibility with legacy Rel-16/17 UEs should be ensured.
      Specify procedures for transmit power control for SL PRS transmissions at least based on open loop power control (OLPC) [RAN1].
      Specify signalling and associated UE behavior for support of unicast, groupcast (not including many to one) and broadcast of SL PRS transmissions [RAN1, RAN2].
      Specify reporting signalling and procedures to facilitate support of SL positioning in all coverage scenarios and for PC5-only and joint PC5-Uu scenarios [RAN2, RAN3]:
         Specify the protocol and procedures for SL positioning between UEs (Protocol for Sidelink positioning procedures (SLPP)).
         Specify the protocol and procedures for SL positioning between UEs and LMF.
      Specify signalling to NG-RAN for sidelink positioning and ranging service authorizations as needed. [RAN3, RAN2]
      Specify corresponding new core requirements, as well as identifying and specify the impact on the existing RAN4 specification, including RRM measurements and procedures [RAN4].
Performance part:
   Define corresponding performance requirements and test cases for expanded and improved NR positioning [RAN4]

The positioning signal design and the measurement discussions are still yet to be finalized in other RAN groups, hence it is difficult to discuss RAN4 requirements for SL positioning at any detail level. However, there are some issues which RAN4 could start discussing in parallel, e.g.:
Coverage states (out-of-coverage, partial coverage, and in-coverage) for which RAN4 needs to define SL positioning requirements,
Requirements for initiation/cease of SL transmissions for positioning,
Synchronization source change impact on SL positioning measurements,
Coverage change impact on SL positioning measurements,
FR2 requirements for SL positioning.
   Coverage States (Out-of-Coverage, Partial Coverage, and in-Coverage) for which RAN4 Needs to Define SL Positioning Requirements:

All coverage scenarios are to be supported for SL positioning, according to [1], which justifies that RAN4 requirements for SL positioning cover all coverage scenarios too.
Proposal 12: RAN4 will define SI positioning requirements to support all coverage scenarios (in-coverage, out-of-coverage, partial coverage).

### Requirements for Initiation/Cease of SL Transmissions for Positioning:

To enable SL positioning measurements, some SL reference signals need to be transmitted for positioning purpose. RAN4 needs to discuss requirements for initiation/cease of SL transmissions for positioning.
Proposal 13: RAN4 to discuss requirements for initiation/cease of SL transmissions for positioning.

### Synchronization Source Change Impact on SL Positioning Measurements:

An SL UE acquires its timing by synchronizing with respect to a synchronization reference source, which can be GNSS, a base station (e.g., gNB, eNB, etc), another SL UE synchronized to GNSS, or own clock. The UE may change its synchronization source right before or during an SL positioning measurement, which may impact the measurement procedure and/or the measurement performance, depending at least on the measurement type. There may also be a need to clarify the UE behavior in such scenarios.
Proposal 14: RAN4 to discuss the impact of a synchronization source change on an SL positioning measurement (e.g., on measurement performance, measurement procedure, UE behavior, etc.).

### Coverage Change Impact on SL Positioning Measurements:

An SL UE can operate in one of the three possible coverage scenarios with respect to a network coverage: in-network coverage, partial network coverage, and out of network coverage. The SL UE may need to be allocated with the same or different set of SL resources for performing the SL positioning measurements in different coverage states. At the same time, the SL positioning measurement, which is used for positioning the target UE, should be accurate and preferably be performed without interruption or minimum interruption. This can be realized if the conditions under which the SL positioning measurement are performed remain stable. However, the coverage of the SL UE with respect to the network can change at any time, because the coverage status/situation depends on several factors which are not under the control of the SL UE, including mobility of the transmitting or receiving SL, interference situation, cell coverage, etc. RAN4 needs to discuss the the impact of the coverage status change on SL positioning measurements, e.g., measurement performance, measurement procedure, UE behavior, etc.
Proposal 15: RAN4 to discuss the impact of a coverage status change on SL positioning measurements (e.g., on measurement performance, measurement procedure, UE behavior, etc.) change.

### FR2 Requirements for SL Positioning:

Given that no FR2 specific aspects should be specified, according to [1], no FR2 core or performance requirements are to be specified by RAN4 for SL positioning.
Proposal 16: No FR2 requirements for SL positioning will be specified in Rel-18.

### Summary

In this contribution we present our view on RRM issues related to Rel. 18 positioning. The discussion in this paper can be summarized into following observations and proposals.
Observation 1: eDRX based requirements are only defined for RedCap UEs.
Observation 2: Positioning measurements (DL-RSTD, DL PRS-RSRPP, DL PRS-RSRP, and UE Rx-Tx time difference) are applicable for RRC_CONNECTED and RRC_INACTIVE modes only.
Observation 3: Depending on how UE is configured to perform MC positioning measurements different core requirements apply.
Proposal 1: RAN4 to define positioning core requirements based on eDRX.
Proposal 2: Define core requirements for RRC_IDLE mode after the applicability of positioning measurements (DL-RSTD, DL PRS-RSRPP, DL PRS-RSRP, and UE Rx-Tx time difference) is extended to RRC_IDLE mode.
Proposal 3: Reuse Rel. 17 core requirements to define core requirements for RedCap UE positioning in RRC_CONNECTED state and RRC_INACTIVE state for 2Rx RedCap UE for FDD/TDD without frequency hopping.
Proposal 4: RAN4 to study and identify core requirements for RedCap UE positioning in RRC_CONNECTED state and RRC_INACTIVE state for 1Rx RedCap FDD/TDD UEs without frequency hopping.
Proposal 5: RAN4 to study and identify core requirement for 1Rx and 2Rx RedCap UEs in RRC_IDLE mode for positioning measurements without frequency hopping.
Proposal 6: RAN4 to study and identify core requirements for 1Rx and 2Rx RedCap UE positioning with frequency hopping after framework/procedure for frequency hopping for positioning is concluded by RAN1/RAN2.
Proposal 7: RAN4 to study and identify core requirement for HD-FDD RedCap UEs (including 1Rx and 2Rx UEs).
Proposal 8: RAN4 to define core requirements when UE is configured only to perform MC positioning measurements without performing MC operation for communication in RRC INACTIVE state and RRC_CONNECTED state.
Proposal 9: RAN4 to define core requirements when UE is configured to simultaneously perform MC operation for communication and MC positioning measurement in RRC CONNECTED state.
Proposal 10: No impact on core requirement if carrier phase is defined as a complimentary measurement that is performed by UE on PRS resource(s) together with the existing positioning measurements.
Proposal 11: RAN4 to evaluate impact on core requirement if carrier phase is defined as a new measurement by RAN1/RAN2.
Proposal 12: RAN4 will define Sl positioning requirements to support all coverage scenarios (in-coverage, out-of-coverage, partial coverage).
Proposal 13: RAN4 to discuss requirements for initation/cease of SL transmissions for positioning.
Proposal 14: RAN4 to discuss the impact of a synchronization source change on an SL positioning measurement (e.g., on measurement performance, measurement procedure, UE behavior, etc.).
Proposal 15: RAN4 to discuss the impact of a coverage status change on SL positioning measurements (e.g., on measurement performance, measurement procedure, UE behavior, etc.) change.
Proposal 16: No FR2 requirements for SL positioning will be specified in Rel-18.

### REFERENCES

[1] RP-223549, “New WID on Expanded and Improved NR Positioning”, Intel Corporation, CATT, Ericsson.
[2] TR38.859, “Study on expanded and improved NR positioning”, 3GPP.

1. A method of operating a first communication device in a communications network that includes a second communication device, the method comprising:
receiving a first sidelink, SL, reference signal, RS, from the second communication device;
determining that a synchronization reference source has changed or is expected to change from a first synchronization reference source to a second synchronization reference source at one or both of the first communication device and the second communication device prior to completing an SL measurement procedure on the first SL RS; and
controlling operation of the first communication device based on determining that the synchronization reference source has changed or is expected to change from the first synchronization reference source to the second synchronization reference source.

2. The method of claim 1, wherein:
the RS is a positioning RS, PRS.

3. The method of claim 1, wherein:
the SL measurement procedure is an SL positioning measurement procedure.

4. The method of claim 1, wherein:
the SL measurement procedure comprises performing an SL measurement over a measurement period.

5. The method of claim 1, wherein:
controlling the operation of the first communication device comprises controlling the SL measurement procedure.

6. The method of claim 5, wherein:
controlling the SL measurement procedure comprises at least one of:
restarting the SL measurement procedure;
continuing the SL measurement procedure;
stopping the SL measurement procedure;
suspending the SL measurement procedure;
restarting a measurement period associated with the SL measurement procedure; and
extending a measurement period associated with the SL measurement procedure.

7. The method of claim 5, wherein:
controlling the SL measurement procedure comprises controlling the SL measurement procedure based on a type of the SL measurement procedure.

8. The method of claim 7, wherein:
controlling the SL measurement procedure based on a type of the SL measurement procedure comprises determining to restart the SL measurement procedure based on the SL measurement procedure including a timing related SL positioning measurement.

9. The method of claim 7, wherein:
controlling the SL measurement procedure based on a type of the SL measurement procedure comprises determining to continue the SL measurement procedure based on the SL measurement procedure including at least one of:
a measurement performed by the first communication device on a signal received from the second communication device;
a measurement performed by the first communication device on signals received from the second communication device and a third communication device; and
a measurement associated with an angle of arrival, AoA.

10. The method of claim 5, wherein:
controlling the SL measurement procedure comprises discarding measurements obtained while using the first synchronization reference source.

11. The method of claim 5, wherein:
determining that the synchronization reference source has changed or is expected to change from the first synchronization reference source to the second synchronization reference source comprises determining that the synchronization reference source has changed or is expected to change from the first synchronization reference source to the second synchronization reference source prior to initiating the SL measurement procedure,
wherein controlling the SL measurement procedure comprises delaying the SL measurement procedure until after the synchronization reference source has changed from the first synchronization reference source to the second synchronization reference source.

12. The method of claim 1, comprising:
initiating the SL measurement procedure prior to initiating a synchronization reference source change procedure,
wherein controlling operation of the first communication device comprises controlling a synchronization reference source procedure based on initiating the SL measurement procedure prior to initiating the synchronization reference source change procedure.

13. The method of claim 12, wherein:
controlling the synchronization reference source procedure comprises at least one of:
canceling the change from the first synchronization reference source to the second synchronization reference source;
delaying the change from the first synchronization reference source to the second synchronization reference source; and
changing from the first synchronization reference source to a third synchronization reference source.

14. The method of claim 12, wherein:
controlling the synchronization reference source procedure comprises controlling the synchronization reference source procedure based on at least one of:
a type of the first synchronization reference source; and
a type of the second synchronization reference source.

15. The method of claim 1, wherein:
controlling the operation of the first communication device comprises controlling the operation of the first communication device based on the first communication device and the second communication device sharing a common synchronization reference source.

16. The method of claim 1, wherein:
determining that the synchronization reference source has changed or is expected to change from the first synchronization reference source to the second synchronization reference source comprises:
measuring a received signal level, RSL, from the first synchronization reference source; and
determining that the synchronization reference source is expected to change from the first synchronization reference source to the second synchronization reference source based on a comparison of the RSL and a threshold value.

17. The method of claim 1, wherein:
determining that the synchronization reference source has changed or is expected to change from the first synchronization reference source to the second synchronization reference source comprises receiving a message from an entity in the communications network, the message indicating that the synchronization reference source has changed or is expected to change from the first synchronization reference source to the second synchronization reference source, and
wherein the entity comprises at least one of:
a network node;
the second communication device; and
a third communication device.

18. The method of claim 1, wherein:
determining that the synchronization reference source has changed or is expected to change from the first synchronization reference source to the second synchronization reference source comprises determining that the synchronization reference source has changed from the first synchronization reference source to the second synchronization reference source.

19. The method of claim 1, comprising:
receiving a second SL RS from the second communication device or from a third communication device; or
transmitting a second SL RS to the second communication device or to the third communication device after executing the controlling operation and completing the SL measurement procedure on the second SL RS.

20. The method of claim 1, comprising:
transmitting a message to an entity, the message including at least one of:
an indication of a change to the operation of the first communication device; and
an indication of a result of the SL measurement procedure.

21-28. (canceled)
